(19) United States
(12) Patent Application Publication
(10) Pub. No.: US 2025/0216650 A1
(43) Pub. Date: Jul. 3, 2025

(54) WIDE-ANGLE LENS ASSEMBLY

(71) Applicant: Asia Optical Co., Inc., Taichung (TW)

(72) Inventors: Yu-Chuan Liang, Taichung (TW); Yan-Jie Syu, Taichung (TW)

(21) Appl. No.: 18/966,345

(22) Filed: Dec. 3, 2024

(30) Foreign Application Priority Data
Dec. 27, 2023 (TW) 112151061
Dec. 27, 2023 (TW) 112151063
Sep. 4, 2024 (CN) 202411229996.3

(51) Int. Cl. G02B 9/64; G02B 13/06

(52) U.S. Cl. CPC G02B 9/64; G02B 13/06

(57) ABSTRACT

A wide-angle lens assembly includes a first lens, a second lens, a third lens, a fourth lens, a fifth lens, and a sixth lens. The first lens is with negative refractive power. The second lens is with refractive power and includes a concave surface facing an object side. The third lens is with positive refractive power. The fourth lens is with refractive power. The fifth lens is with refractive power. The sixth lens is with refractive power. The first lens, the second lens, the third lens, the fourth lens, the fifth lens, and the sixth lens are arranged in order from the object side to an image side along an optical axis.

### BACKGROUND OF THE INVENTION

### Field of the Invention

The present invention relates to a wide-angle lens assembly.

### Description of the Related Art

The current development trend of a wide-angle lens assembly is toward large field of view. Additionally, the wide-angle lens assembly is developed to have miniaturization and high resolution in accordance with different application requirements. However, the known wide-angle lens assembly can't satisfy such requirements. Therefore, the wide-angle lens assembly needs a new structure in order to meet the requirements of large field of view, miniaturization, and high resolution at the same time.

### BRIEF SUMMARY OF THE INVENTION

In view of this, the main purpose of the present invention is to provide a wide-angle lens assembly with characteristics of a decreased total lens length and still has a good optical performance.

The wide-angle lens assembly in accordance with an exemplary embodiment of the invention includes a first lens, a second lens, a third lens, a fourth lens, a fifth lens, and a sixth lens. The first lens is with negative refractive power. The second lens is with refractive power and includes a concave surface facing an object side. The third lens is with positive refractive power. The fourth lens is with refractive power. The fifth lens is with refractive power. The sixth lens is with refractive power. The first lens, the second lens, the third lens, the fourth lens, the fifth lens, and the sixth lens are arranged in order from the object side to an image side along an optical axis. The wide-angle lens assembly satisfies at least one of the following conditions: −70≤R21/d45≤−18; 5 mm²≤(Ra-R21)×d45≤11 mm²; −2.95≤R62/T6≤−2.01; 0.35≤(R11-R12)/TTL≤0.61; 1.86≤BFL/f≤1.99; 0.47≤f/AAG≤0.76; 4.5<L/f<6.9; 3.4<R11/f<5.5; wherein: f is an effective focal length of the wide-angle lens assembly; R11 is a radius of curvature of an object side surface of the first lens; R12 is a radius of curvature of an image side surface of the first lens; R21 is a radius of curvature of an object side surface of the second lens; R62 is a radius of curvature of an image side surface of the sixth lens; d45 is an interval from an image side surface of the lens second closest to a stop and between the stop and the object side to an object side surface of the lens closest to the stop and between the stop and the object side along the optical axis; Ra is a radius of curvature of an object side surface of the lens closest to the stop and between the stop and an image plane; T6 is an interval from an object side surface of the sixth lens to an image side surface of the sixth lens along the optical axis; TTL is an interval from the object side surface of the first lens to the image plane along the optical axis; BFL is an interval from an image side surface of the lens closest to the image plane to the image plane along the optical axis; AAG is a sum of air intervals between the first lens and the lens closest to the image plane along the optical axis; and L is an interval from the object side surface of the first lens to the image side surface of the lens closest to the image plane along the optical axis.

In another exemplary embodiment, the wide-angle lens assembly satisfies at least one of the following conditions: 2.5 mm≤Ra/Nd4≤15 mm; 5≤Ra/d67≤62; 2 mm≤Ra+Rd≤19 mm; −1 mm<fb+Rc<2 mm; 0.14<Ra/fc<6.62; 3 mm⁻¹<Vdb/Rc<7 mm⁻¹; 0.14 mm<Ra/Vdb<1.34 mm; −2.3<f1/f<−1.5; −38.3<Vdd/(fc/fb)<−15.2; 0.14<f/TTL<0.18; 3.1<TTL/BFL<8.1; wherein: Ra is the radius of curvature of the object side surface of the lens closest to the stop and between the stop and the image plane; Rd is a radius of curvature of an object side surface of the lens second closest to the image plane; Nd4 is a refractive index of the lens closest to the stop and between the stop and the image plane; d67 is an interval from an image side surface of the lens closest to the stop and between the object side and the stop to the stop along the optical axis; f is the effective focal length of the wide-angle lens assembly; f1 is an effective focal length of the first lens; fb is an effective focal length of the lens second closest to the stop and between the stop and the image plane; fc is an effective focal length of the lens closest to the image plane; TTL is the interval from the object side surface of the first lens to the image plane along the optical axis; BFL is the interval from the image side surface of the lens closest to the image plane to the image plane along the optical axis; L is the interval from the object side surface of the first lens to the image side surface of the lens closest to the image plane along the optical axis; Rc is a radius of curvature of an object side surface of the lens closest to the image plane; Vdb is an Abbe number of the lens second closest to the stop and between the stop and the image plane; Vdd is an Abbe number of the lens second closest to the image plane; and R11 is the radius of curvature of the object side surface of the first lens.

In yet another exemplary embodiment, the wide-angle lens assembly further includes a seventh lens disposed between the sixth lens and the image side, wherein: the first lens is a meniscus lens and includes a convex surface facing the object side and a concave surface facing the image side; the second lens is a meniscus lens with positive refractive power and further includes a convex surface facing the image side; the third lens includes a convex surface facing the object side; the fourth lens is a biconvex lens with positive refractive power and includes a convex surface facing the object side and another convex surface facing the image side; the fifth lens is a biconcave lens with negative refractive power and includes a concave surface facing the object side and another concave surface facing the image side; the sixth lens is a meniscus lens with positive refractive power and includes a convex surface facing the object side and a concave surface facing the image side; and the seventh lens is a plano-convex lens with positive refractive power and includes a convex surface facing the object side and a plane surface facing the image side.

In another exemplary embodiment, the third lens is a meniscus lens and further includes a concave surface facing the image side.

In yet another exemplary embodiment, the first lens is a meniscus lens and includes a convex surface facing the object side and a concave surface facing the image side; the third lens is a biconvex lens and includes a convex surface facing the object side and another convex surface facing the image side; the fourth lens is a biconvex lens with positive refractive power and includes a convex surface facing the object side and another convex surface facing the image side; the fifth lens is a biconcave lens with negative refractive power and includes a concave surface facing the object side and another concave surface facing the image side; and the sixth lens is a meniscus lens with positive refractive power and includes a convex surface facing the object side.

In another exemplary embodiment, the second lens is a biconcave lens with negative refractive power and further includes another concave surface facing the image side; and the sixth lens further includes another convex surface facing the image side.

In yet another exemplary embodiment, the fourth lens is with positive refractive power; the fifth lens is with negative refractive power; and the sixth lens is with positive refractive power.

In another embodiment, the wide-angle lens assembly further includes a seventh lens disposed between the sixth lens and the image side, wherein the seventh lens is a plano-convex lens with positive refractive power and includes a convex surface facing the object side and a plane surface facing the image side.

In yet another exemplary embodiment, the first lens is a meniscus lens and includes a convex surface facing the object side and a concave surface facing the image side; the third lens includes a convex surface facing the object side; the fourth lens is a biconvex lens and includes a convex surface facing the object side and another convex surface facing the image side; the fifth lens is a biconcave lens and includes a concave surface facing the object side and another concave surface facing the image side; and the sixth lens is a meniscus lens and includes a convex surface facing the object side.

In another exemplary embodiment, the second lens is a meniscus lens with positive refractive power and further includes a convex surface facing the image side; and the sixth lens further includes a concave surface facing the image side.

In yet another embodiment, the third lens is a biconvex lens and further includes another convex surface facing the image side.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout and optical path diagram of a wide-angle lens assembly in accordance with a fourth embodiment of the invention;

FIGS. 2, 3, and 4 depict a longitudinal aberration diagram, a field curvature diagram, and a distortion diagram of the wide-angle lens assembly in accordance with the fourth embodiment of the invention, respectively;

FIG. 5 is a lens layout and optical path diagram of a wide-angle lens assembly in accordance with a fifth embodiment of the invention;

FIGS. 6, 7, and 8 depict a longitudinal aberration diagram, a field curvature diagram, and a distortion diagram of the wide-angle lens assembly in accordance with the fifth embodiment of the invention, respectively;

FIG. 9 is a lens layout and optical path diagram of a wide-angle lens assembly in accordance with a sixth embodiment of the invention;

FIGS. 10, 11, and 12 depict a longitudinal aberration diagram, a field curvature diagram, and a distortion diagram of the wide-angle lens assembly in accordance with the sixth embodiment of the invention, respectively;

FIG. 13 is a lens layout and optical path diagram of a wide-angle lens assembly in accordance with a seventh embodiment of the invention;

FIGS. 14, 15, and 16 depict a longitudinal aberration diagram, a field curvature diagram, and a distortion diagram of the wide-angle lens assembly in accordance with the seventh embodiment of the invention, respectively;

FIG. 17 is a lens layout and optical path diagram of a wide-angle lens assembly in accordance with an eighth embodiment of the invention;

FIGS. 18, 19, and 20 depict a longitudinal aberration diagram, a field curvature diagram, and a distortion diagram of the wide-angle lens assembly in accordance with the eighth embodiment of the invention, respectively;

FIG. 21 is a lens layout and optical path diagram of a wide-angle lens assembly in accordance with a ninth embodiment of the invention;

FIGS. 22, 23, and 24 depict a longitudinal aberration diagram, a field curvature diagram, and a distortion diagram of the wide-angle lens assembly in accordance with the ninth embodiment of the invention, respectively; and

FIG. 25 is a lens layout and optical path diagram of a wide-angle lens assembly in accordance with a tenth embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a wide-angle lens assembly in accordance with a first embodiment of the invention including a first lens, a second lens, a third lens, a fourth lens, a fifth lens, a sixth lens, and a seventh lens. The first lens is with negative refractive power and includes a convex surface facing an object side. The second lens is with refractive power. The third lens is with refractive power. The fourth lens is with positive refractive power. The fifth lens is with negative refractive power. The sixth lens is with refractive power and includes a concave surface facing an image side. The seventh lens is with positive refractive power. The first lens, the second lens, the third lens, the fourth lens, the fifth lens, the sixth lens, and the seventh lens are arranged in order from the object side to the image side along an optical axis. In operation, the light from the object side is imaged on an image plane. The wide-angle lens assembly in accordance with the first embodiment of the invention can achieve the basic operation requirements through the above design.

The present invention provides a wide-angle lens assembly in accordance with a second embodiment of the invention including a first lens, a second lens, a third lens, a fourth lens, a fifth lens, a sixth lens, and a seventh lens. The first lens is a meniscus lens with refractive power. The second lens is with refractive power. The third lens is with refractive power. The fourth lens is with refractive power. The fifth lens is with refractive power. The sixth lens is with refractive power. The seventh lens is with refractive power. Only one lens among the second lens, the third lens, the fourth lens, the fifth lens, the sixth lens and the seventh lens is a biconcave lens. There are two lenses with positive refractive power are disposed between two lenses with negative refractive power. The first lens, the second lens, the third lens, the fourth lens, the fifth lens, the sixth lens, and the seventh lens are arranged in order from an object side to an image side along an optical axis. In operation, the light from the object side is imaged on an image plane. The wide-angle lens assembly in accordance with the second embodiment of the invention can achieve the basic operation requirements through the above design.

The present invention provides a wide-angle lens assembly in accordance with a third embodiment of the invention including a first lens, a second lens, a third lens, a fourth lens, a fifth lens, a sixth lens, and a seventh lens. The first lens is with negative refractive power and includes a convex surface facing an object side. The second lens is a meniscus lens with refractive power. The third lens is with refractive power. The fourth lens is with positive refractive power. The fifth lens is with negative refractive power. The sixth lens is a meniscus lens with refractive power and includes a concave surface facing an image side. The seventh lens is with positive refractive power. The refractive powers of the first lens and the second lens are opposite. The object side surface shape of the first lens is similar to the image side surface shape of the second lens. The refractive powers of the first lens and the sixth lens are opposite. The image side surface shape of the first lens is similar to the image side surface shape of the sixth lens. The first lens, the second lens, the third lens, the fourth lens, the fifth lens, the sixth lens, and the seventh lens are arranged in order from the object side to the image side along an optical axis. In operation, the light from the object side is imaged on an image plane. The wide-angle lens assembly in accordance with the third embodiment of the invention can achieve the basic operation requirements through the above design.

In addition, in another embodiment of each of the above wide-angle lens assemblies can further satisfies the condition: −1 mm<fb+Rc<2 mm; wherein fb is an effective focal length of the lens second closest to the stop and between the stop and the image plane and Rc is a radius of curvature of the object side surface of the lens closest to the image plane, so as to effectively correct the angle of light incident on the photosensitive element. The basic operation can be achieved when the condition: −1 mm<fb+Rc<2 mm is satisfied. In yet another embodiment of each of the above wide-angle lens assemblies can further satisfies the condition: 0.14<Ra/fc<6.62; wherein Ra is a radius of curvature of the object side surface of the lens closest to the stop and between the stop and the image plane and fc is an effective focal length of the lens closest to the image plane, so as to effectively compensate for performance degradation caused by high temperature environments and improve Monte Carlo yield. The basic operation can be achieved when the condition: 0.14<Ra/fc<6.62 is satisfied. In another embodiment of each of the above wide-angle lens assemblies can further satisfies the condition: 3 mm⁻¹<Vdb/Rc<7 mm⁻¹; wherein Vdb is an Abbe number of the lens second closest to the stop and between the stop and the image plane and Re is a radius of curvature of the object side surface of the lens closest to the image plane, so as to effectively correct lens sensitivity and improve Monte Carlo yield. The basic operation can be achieved when the condition: 3 mm⁻¹<Vdb/Rc<7 mm⁻¹ is satisfied. In yet another embodiment of each of the above wide-angle lens assemblies can further satisfies the condition: 0.14 mm<Ra/Vdb<1.34 mm; wherein Ra is the radius of curvature of the object side surface of the lens closest to the stop and between the stop and the image plane and Vdb is an Abbe number of the lens second closest to the stop and between the stop and the image plane, so as to effectively reduce the impact of stray light on photosensitive elements. The basic operation can be achieved when the condition: 0.14 mm<Ra/Vdb<1.34 mm is satisfied. In another embodiment of each of the above wide-angle lens assemblies can further satisfies the condition: −2.3<f1/f<−1.5; wherein f1 is an effective focal length of the first lens and f is an effective focal length of the wide-angle lens assembly, so as to effectively increase the field of view. The basic operation can be achieved when the condition: −2.3<f1/f<−1.5 is satisfied. In yet another embodiment of each of the above wide-angle lens assemblies can further satisfies the condition: −38.3<Vdd/(fc/fb)<−15.2; wherein Vdd is an Abbe number of the lens second closest the image plane, fc is an effective focal length of the lens closest to the image plane, and fb is an effective focal length of the lens second closest to the stop and between the stop and the image plane, so as to effectively increase the image quality. The basic operation can be achieved when the condition: −38.3<Vdd/(fc/fb)<−15.2 is satisfied. In another embodiment of each of the above wide-angle lens assemblies can further satisfies the condition: 0.14<f/TTL<0.18; wherein f is an effective focal length of the wide-angle lens assembly and TTL is an interval from the object side surface of the first lens to the image plane along the optical axis, so as to effectively decrease the volume of the wide-angle lens assembly. The basic operation can be achieved when the condition: 0.14<f/TTL<0.18 is satisfied. In yet another embodiment of each of the above wide-angle lens assemblies can further satisfies the condition: 3.1<TTL/BFL<8.1; wherein TTL is an interval from the object side surface of the first lens to the image plane along the optical axis and BFL is an interval from the image side surface of the lens closest to the image plane to the image plane along the optical axis, so as to effectively decrease the volume of the wide-angle lens assembly. The basic operation can be achieved when the condition: 3.1<TTL/BFL<8.1 is satisfied. In another embodiment of each of the above wide-angle lens assemblies can further satisfies the condition: 4.5<L/f<6.9; wherein L is an interval from the object side surface of the first lens to the image side surface of the lens closest to the image plane along the optical axis and f is the effective focal length of the wide-angle lens assembly, so as to effectively decrease the volume of the wide-angle lens assembly. The basic operation can be achieved when the condition: 4.5<L/f<6.9 is satisfied. In yet another embodiment of each of the above wide-angle lens assemblies can further satisfies the condition: 3.4<R11/f<5.5; wherein R11 is a radius of curvature of the object side surface of the first lens and f an effective focal length of the wide-angle lens assembly, so as to effectively increase the image quality. The basic operation can be achieved when the condition: 3.4<R11/f<5.5 is satisfied.

Referring to Table 1, Table 2, Table 4, Table 5, Table 7, and Table 8, wherein Table 1, Table 4, and Table 7 show optical specification in accordance with a fourth, fifth, and sixth embodiments of the invention, respectively, and Table 2, Table 5, and Table 8 show aspheric coefficients of each aspheric lens in Table 1, Table 4, and Table 7, respectively.

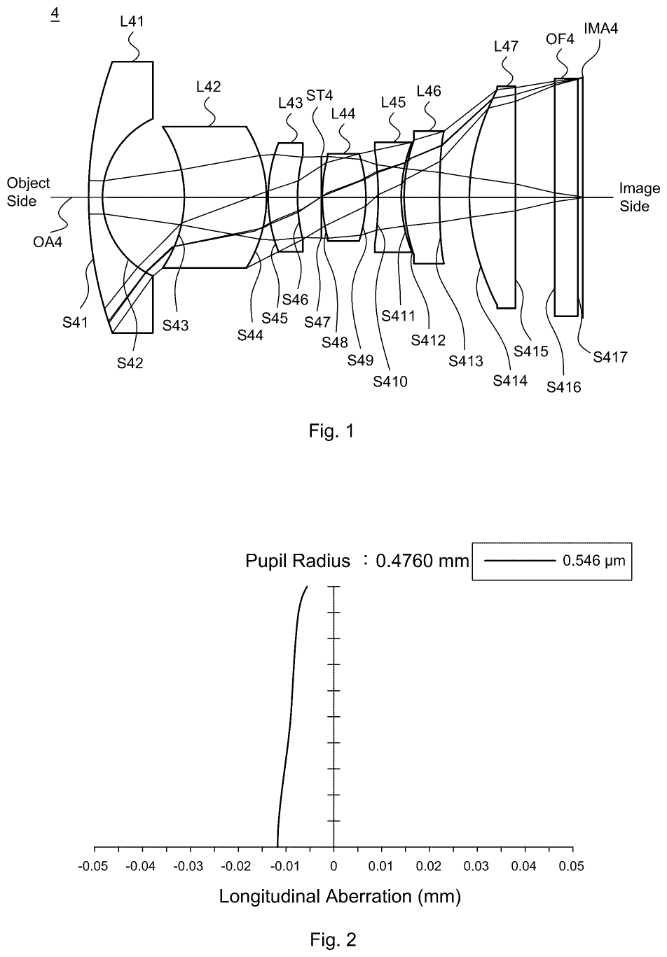

FIGS. 1, 5, and 9 are lens layout and optical path diagrams of wide-angle lens assemblies in accordance with a fourth, fifth, and sixth embodiments of the invention, respectively.

The first lenses L41, L51, L61 are meniscus lenses with negative refractive power, wherein the object side surfaces S41, S51, S61 are convex surfaces, the image side surfaces S42, S52, S62 are concave surfaces, and both of the object side surfaces S41, S51, S61 and image side surfaces S42, S52, S62 are spherical surfaces.

The second lenses L42, L52, L62 are meniscus lenses with positive refractive power, wherein the object side surfaces S43, S53, S63 are concave surfaces, the image side surfaces S44, S54, S64 are convex surfaces, and both of the object side surfaces S43, S53, S63 and image side surfaces S44, S54, S64 are aspheric surfaces.

The third lenses L43, L53, L63 are with positive refractive power, wherein the object side surfaces S45, S55, S65 are convex surfaces.

The fourth lenses L44, L54, L64 are biconvex lenses with positive refractive power, wherein the object side surfaces S48, S58, S68 are convex surfaces, the image side surfaces S49, S59, S69 are convex surfaces, and both of the object side surfaces S48, S58, S68 and image side surfaces S49, S59, S69 are spherical surfaces.

The fifth lenses L45, L55, L65 are biconcave lenses with negative refractive power, wherein the object side surfaces S410, S510, S610 are concave surfaces, the image side surfaces S411, S511, S611 are concave surfaces, and both of the object side surfaces S410, S510, S610 and image side surfaces S411, S511, S611 are aspheric surfaces.

The sixth lenses L46, L56, L56 are meniscus lenses with positive refractive power, wherein the object side surfaces S412, S512, S612 are convex surfaces, the image side surfaces S413, S513, S613 are concave surfaces, and both of the object side surfaces S412, S512, S612 and image side surfaces S413, S513, S613 are aspheric surfaces.

The seventh lenses L47, L57, L57 are plano-convex lenses with positive refractive power, wherein the object side surfaces S414, S514, S614 are convex surfaces, the image side surfaces S415, S515, S615 are plane surfaces, and the object side surfaces S414, S514, S614 are aspheric surfaces.

In addition, the wide-angle lens assemblies 4, 5, and 6 can optimize the performance by satisfying at least one or all of the following conditions (1)-(10). The optimized performance is as described above and is not described here again:

$$- 1 mm < fb + R c < 2 mm ; \qquad ( 1 )$$

$$0.14 < Ra / fc < 6 \text{.62} ; \qquad ( 2 )$$

$$3 {mm}^{- 1} < Vdb / Rc < 7 {mm}^{- 1} ; \qquad ( 3 )$$

$$0.14 mm < Ra / Vdb < 1.34 mm ; \qquad ( 4 )$$

$$- 2.3 < f 1 / f < - 1.5 ; \qquad ( 5 )$$

$$- 38.3 < Vdd / ( fc / fb ) < - 15.2 ; \qquad ( 6 )$$

$$0.14 < f / TTL < 0.18 ; \qquad ( 7 )$$

$$3.1 < TTL / BFL < 8.1 ; \qquad ( 8 )$$

$$4.5 < L / f < 6.9 ; \qquad ( 9 )$$

$$3.4 < R 11 / f < 5.5 ; \qquad ( 10 )$$

wherein: f is an effective focal length of the wide-angle lens assemblies 4, 5, 6 for the fourth to sixth embodiments; f1 is an effective focal length of the first lenses L41, L51, L61 for the fourth to sixth embodiments; fb is an effective focal length of the lenses second closest to the stops ST4, ST5, ST6 and between the stops ST4, ST5, ST6 and the image planes IMA4, IMA5, IMA6 for the fourth to sixth embodiments; fc is an effective focal length of the lenses closest to the image planes IMA4, IMA5, IMA6 for the fourth to sixth embodiments; TTL is an interval from the object side surfaces S41, S51, S61 of the first lenses L41, L51, L61 to the image planes IMA4, IMA5, IMA6 along the optical axes OA4, OA5, OA6 for the fourth to sixth embodiments; BFL is an interval from the image side surfaces S415, S515, S615 of the lenses L47, L57, L67 closest to the image planes IMA4, IMA5, IMA6 to the image planes IMA4, IMA5, IMA6 along the optical axes OA4, OA5, OA6 for the fourth to sixth embodiments; L is an interval from the object side surfaces S41, S51, S61 of the first lenses L41, L51, L61 to the image side surfaces S415, S515, S615 of the lenses closest to the image planes IMA4, IMA5, IMA6 along the optical axes OA4, OA5, OA6 for the fourth to sixth embodiments; Ra is a radius of curvature of the object side surfaces S48, S58, S68 of the lenses closest to the stops ST4, ST5, ST6 and between the stops ST4, ST5, ST6 and the image planes IMA4, IMA5, IMA6 for the fourth to sixth embodiments; Rc is a radius of curvature of the object side surfaces S414, S514, S614 of the lenses closest to the image planes IMA4, IMA5, IMA6 for the fourth to sixth embodiments; Vdb is an Abbe number of the lenses second closest to the stops ST4, ST5, ST6 and between the stops ST4, ST5, ST6 and the image planes IMA4, IMA5, IMA6 for the fourth to sixth embodiments; Vdd is an Abbe number of the lenses second closest to the image planes IMA4, IMA5, IMA6 for the fourth to sixth embodiments; and R11 is a radius of curvature of the object side surfaces S41, S51, S61 of the first lenses L41, L51, L61 for the fourth to sixth embodiments. Making the wide-angle lens assemblies 4, 5, 6 effectively shortening the total lens length, effectively increasing the field of view, effectively increasing the resolution, and effectively correcting aberration.

A detailed description of a wide-angle lens assembly in accordance with a fourth embodiment of the invention is as follows. Referring to FIG. 1, the wide-angle lens assembly 4 includes a first lens L41, a second lens L42, a third lens L43, a stop ST4, a fourth lens L44, a fifth lens L45, a sixth lens L46, a seventh lens L47, and an optical filter OF4, all of which are arranged in order from an object side to an image side along an optical axis OA4. In operation, the light from the object side is imaged on an image plane IMA4. According to the foregoing, wherein: the third lens L43 is a meniscus lens, wherein the image side surface S46 is a concave surface and both of the object side surface S45 and image side surface S46 are aspheric surfaces; both of the object side surface S416 and image side surface S417 of the optical filter OF4 are plane surfaces; and with the above design of the lenses, stop ST4, and at least one of the conditions (1)-(10) satisfied, the wide-angle lens assembly 4 can have an effective decreased total lens length, an effective increased field of view, an effective increased resolution, and an effective corrected aberration. When the wide-angle lens assembly of the present invention only satisfies condition (1), condition (2), condition (3), condition (4), or condition (6); the first, fourth, fifth and seventh lenses respectively have negative, positive, negative, positive refractive power; the object side surface of the first lens is a convex surface and the image side surface of the first lens is a concave surface; and the image side surface of the sixth lens is a concave surface; the basic operation requirements can be met; or only satisfies condition (1), condition (2), condition (3), condition (4), or condition (6); the first, fourth, fifth and seventh lenses respectively have negative, positive, negative, positive refractive power; the image side surface of the sixth lens is a concave surface; and the object side surface of the seventh lens is a convex surface and the image side surface of the seventh lens is a plane surface; the basic action requirements can be met; or only satisfies condition (1), condition (2), condition (3), condition (4) or condition (6); at least two lenses with positive refractive power are disposed between two lenses with negative refractive power; and at least one lens among the second to seventh lenses being a biconcave lens; the basic operation requirements can be met.

Table 1 shows the optical specification of the wide-angle lens assembly 4 in FIG. 1.

TABLE 1
Effective Focal Length = 2.284 mm F-number = 2.25
Total Lens Length = 14.94 mm Field of View = 150.1 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S41 | 10.24 | 0.41 | 1.82 | 46.57 | −3.74 | L41 |
| S42 | 2.32 | 2.48 | | | | |
| S43 | −3.30 | 2.48 | 1.55 | 56.00 | 17.49 | L42 |
| S44 | −3.11 | 0.05 | | | | |
| S45 | 4.00 | 0.89 | 1.64 | 23.35 | 29.92 | L43 |
| S46 | 4.61 | 0.72 | | | | |
| S47 | ∞ | 0.02 | | | | ST4 |
| S48 | 3.93 | 1.32 | 1.52 | 60.61 | 3.90 | L44 |
| S49 | −3.66 | 0.37 | | | | |
| S410 | −11.18 | 0.70 | 1.67 | 19.24 | −3.78 | L45 |
| S411 | 3.42 | 0.09 | | | | |
| S412 | 4.49 | 1.07 | 1.55 | 56.00 | 10.00 | L46 |
| S413 | 22.96 | 0.90 | | | | |
| S414 | 4.89 | 1.40 | 1.55 | 56.00 | 8.95 | L47 |
| S415 | ∞ | 1.19 | | | | |
| S416 | ∞ | 0.70 | 1.52 | 64.17 | | OF4 |
| S417 | ∞ | 0.15 | | | | |

The aspheric surface sag z of each lens in table 1 can be calculated by the following formula:

$$z = c {h}^{2} / \{ 1 + {[ 1 ( k + 1 ) {c}^{2} {h}^{2} ]}^{1 / 2} \} + A {h}^{4} + B {h}^{6} + C {h}^{8} + D {h}^{10}$$

where c is curvature, h is the vertical distance from the lens surface to the optical axis, k is conic constant and A, B, C, and D are aspheric coefficients.

In the first embodiment, the conic constant k and the aspheric coefficients A, B, C, D of each aspheric lens are shown in Table 2.

TABLE 2

| Surface | | | | | |
|---|---|---|---|---|---|
| Number | k | A | B | C | D |
| S43 | 0.00E+00 | −4.64E−03 | 2.64E−04 | −1.04E−04 | −4.22E−06 |
| S44 | 0.00E+00 | 8.12E−03 | −8.58E−04 | 8.87E−05 | 2.52E−06 |
| S45 | 0.00E+00 | 1.92E−03 | 1.54E−03 | −5.05E−04 | 4.30E−05 |
| S46 | 0.00E+00 | −7.38E−03 | 2.76E−03 | −7.76E−04 | −1.75E−04 |
| S410 | 0.00E+00 | −8.82E−03 | 4.20E−03 | −9.91E−04 | 1.33E−04 |
| S411 | 0.00E+00 | 1.78E−02 | −3.25E−04 | −3.73E−04 | 0.00E+00 |
| S412 | 0.00E+00 | 1.76E−02 | −3.79E−04 | −4.66E−04 | 5.41E−05 |
| S413 | 0.00E+00 | 4.11E−03 | 7.97E−04 | −2.77E−04 | 6.22E−05 |
| S414 | 0.00E+00 | 7.92E−03 | −1.11E−03 | 8.72E−05 | −2.20E−06 |

Table 3 shows the parameters and condition values for conditions (1)-(10) in accordance with the fourth embodiment of the invention. It can be seen from Table 3 that the wide-angle lens assembly 4 of the fourth embodiment satisfies the conditions (1)-(10).

TABLE 3

| fb | −3.78 | mm | Rc | 4.89 | mm | Ra | 3.93 | mm |
|---|---|---|---|---|---|---|---|---|
| fc | 8.95 | mm | Vdb | 19.24 | | Vdd | 56.00 | |
| BFL | 2.04 | mm | L | 12.90 | mm | | | |
| fb + | 1.11 | mm | Ra/fc | 0.44 | | Vdb/Rc | 3.94 | mm⁻¹ |
| Rc | | | | | | | | |

| | | | | | | |
|---|---|---|---|---|---|---|
| Ra/Vdb | 0.20 | mm | f1/f | −1.64 | Vdd/ | −23.68 |

| | | | | (fc/fb) | |
|---|---|---|---|---|---|
| f/TTL | 0.15 | TTL/BFL | 7.32 | L/f | 5.65 |
| R11/f | 4.48 | | | | |

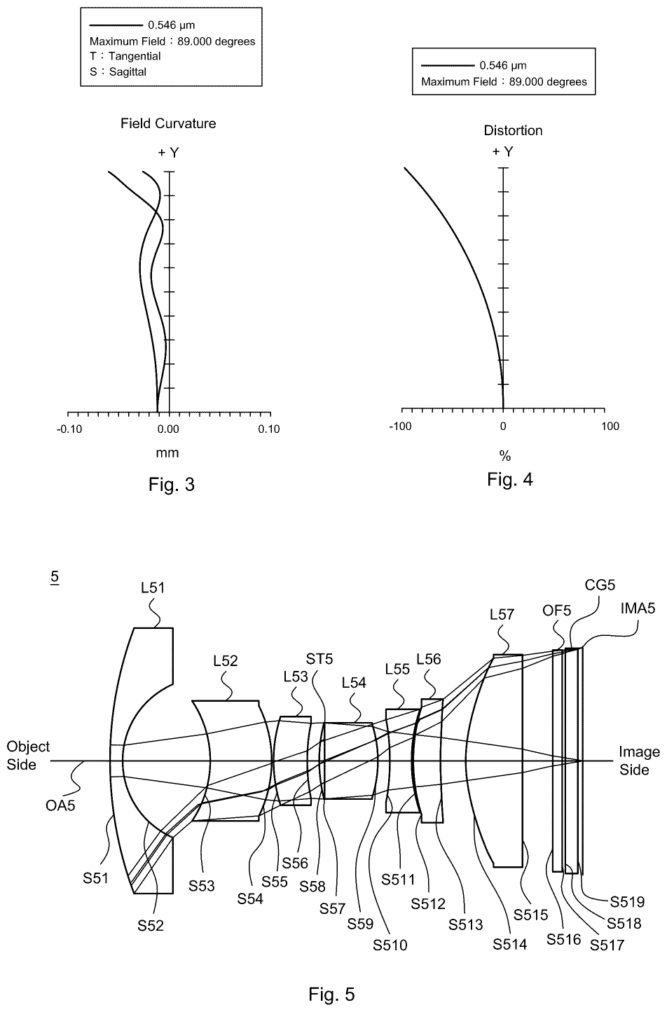

In addition, the wide-angle lens assembly 4 of the fourth embodiment can meet the requirements of optical performance as seen in FIGS. 2-4. It can be seen from FIG. 2 that the longitudinal aberration in the wide-angle lens assembly 4 of the fourth embodiment ranges from −0.015 mm to 0.05 mm. It can be seen from FIG. 3 that the field curvature of tangential direction and sagittal direction in the wide-angle lens assembly 4 of the fourth embodiment ranges from −0.06 mm to 0 mm. It can be seen from FIG. 4 that the distortion in the wide-angle lens assembly 4 of the fourth embodiment ranges from −100% to 0%. It is obvious that the longitudinal aberration, the field curvature and the distortion of the wide-angle lens assembly 4 of the fourth embodiment can be corrected effectively. Therefore, the wide-angle lens assembly 4 of the fourth embodiment is capable of good optical performance.

A detailed description of a wide-angle lens assembly in accordance with a fifth embodiment of the invention is as follows. Referring to FIG. 5, the wide-angle lens assembly 5 includes a first lens L51, a second lens L52, a third lens L53, a stop ST5, a fourth lens L54, a fifth lens L55, a sixth lens L56, a seventh lens L57, an optical filter OF5, and a cover glass CG5, all of which are arranged in order from an object side to an image side along an optical axis OA5. In operation, the light from the object side is imaged on an image plane IMA5. According to the foregoing, wherein: the third lens L53 is a meniscus lens, wherein the image side surface S56 is a concave surface and both of the object side surface S55 and image side surface S56 are aspheric surfaces; both of the object side surface S516 and image side surface S517 of the optical filter OF5 are plane surfaces; both of the object side surface S518 and image side surface S519 of the cover glass CG5 are plane surfaces; and with the above design of the lenses, stop ST5, and at least one of the conditions (1)-(10) satisfied, the wide-angle lens assembly 5 can have an effective decreased total lens length, an effective increased field of view, an effective increased resolution, and an effective corrected aberration. When the wide-angle lens assembly of the present invention only satisfies condition (5), condition (9), or condition (10); the first, fourth, fifth and seventh lenses respectively have negative, positive, negative, positive refractive power; the object side surface of the first lens is a convex surface and the image side surface of the first lens is a concave surface; and the image side surface of the sixth lens is a concave surface; the basic operation requirements can be met; or only satisfies condition (5), condition (9), or condition (10); the first, fourth, fifth and seventh lenses respectively have negative, positive, negative, positive refractive power; the image side surface of the sixth lens is a concave surface; and the object side surface of the seventh lens is a convex surface and the image side surface of the seventh lens is a plane surface; the basic action requirements can be met; or only satisfies condition (5), condition (9), or condition (10); at least two lenses with positive refractive power are disposed between two lenses with negative refractive power; and at least one lens among the second to seventh lenses being a biconcave lens; the basic operation requirements can be met.

Table 4 shows the optical specification of the wide-angle lens assembly 5 in FIG. 5.

TABLE 4
Effective Focal Length = 2.283 mm F-number = 2.23
Total Lens Length = 15.03 mm Field of View = 150.2 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S51 | 10.32 | 0.41 | 1.82 | 46.57 | −3.87 | L51 |
| S52 | 2.38 | 2.78 | | | | |
| S53 | −2.69 | 1.95 | 1.55 | 56.00 | 35.90 | L52 |
| S54 | −2.98 | 0.06 | | | | |
| S55 | 4.09 | 1.07 | 1.64 | 23.35 | 22.01 | L53 |
| S56 | 5.15 | 0.55 | | | | |
| S57 | ∞ | −0.17 | | | | ST5 |
| S58 | 4.07 | 1.87 | 1.52 | 60.61 | 3.83 | L54 |
| S59 | −3.25 | 0.38 | | | | |
| S510 | −7.33 | 0.69 | 1.67 | 19.24 | −4.01 | L55 |
| S511 | 4.51 | 0.05 | | | | |
| S512 | 4.63 | 0.86 | 1.55 | 56.00 | 15.52 | L56 |
| S513 | 9.52 | 0.81 | | | | |
| S514 | 3.86 | 1.80 | 1.55 | 56.00 | 7.06 | L57 |
| S515 | ∞ | 0.97 | | | | |
| S516 | ∞ | 0.30 | 0.52 | 64.17 | | OF5 |
| S517 | ∞ | 0.10 | | | | |
| S518 | ∞ | 0.40 | 0.52 | 64.17 | | CG5 |
| S519 | ∞ | 0.15 | | | | |

The definition of aspheric surface sag z of each aspheric lens in Table 4 is the same as that of in Table 1, and is not described here again.

In the fifth embodiment, the conic constant k and the aspheric coefficients A, B, C, D, of each aspheric lens are shown in Table 5.

TABLE 5

| Surface | | | | | |
|---|---|---|---|---|---|
| Number | k | A | B | C | D |
| S53 | 0.00E+00 | −3.03E−03 | 4.49E−04 | −1.16E−04 | −8.45E−06 |
| S54 | 0.00E+00 | 1.04E−02 | −2.02E−04 | −1.25E−04 | 1.93E−05 |
| S55 | 0.00E+00 | 2.68E−03 | 4.56E−04 | 2.51E−04 | −1.22E−04 |
| S56 | 0.00E+00 | −6.57E−03 | 1.21E−03 | 1.77E−03 | −7.90E−04 |
| S510 | 0.00E+00 | −6.23E−03 | 4.02E−03 | −1.68E−03 | 4.61E−04 |
| S511 | 0.00E+00 | 1.89E−02 | −2.84E−04 | −7.31E−04 | 0.00E+00 |
| S512 | 0.00E+00 | 1.68E−02 | −1.05E−03 | 4.16E−05 | −9.70E−05 |
| S513 | 0.00E+00 | −8.69E−03 | 1.88E−03 | −1.69E−04 | 6.61E−05 |
| S514 | 0.00E+00 | 4.85E−03 | −8.72E−04 | 9.53E−05 | −3.11E−06 |

Table 6 shows the parameters and condition values for conditions (1)-(10) in accordance with the fifth embodiment of the invention. It can be seen from Table 6 that the wide-angle lens assembly 5 of the fifth embodiment satisfies the conditions (1)-(10).

TABLE 6

| fb | −4.01 | mm | Rc | 3.86 | mm | Ra | 4.07 | mm |
|---|---|---|---|---|---|---|---|---|
| fc | 7.06 | mm | Vdb | 19.24 | | Vdd | 56.00 | |
| BFL | 1.92 | mm | L | 13.12 | mm | | | |
| fb + | −0.16 | mm | Ra/fc | 0.58 | | Vdb/Rc | 4.99 | mm⁻¹ |
| Rc | | | | | | | | |

| | | | | | | |
|---|---|---|---|---|---|---|
| Ra/Vdb | 0.21 | mm | f1/f | −1.69 | Vdd/ | −31.83 |

| | | | | (fc/fb) | |
|---|---|---|---|---|---|
| f/TTL | 0.15 | TTL/BFL | 7.83 | L/f | 5.75 |
| R11/f | 4.52 | | | | |

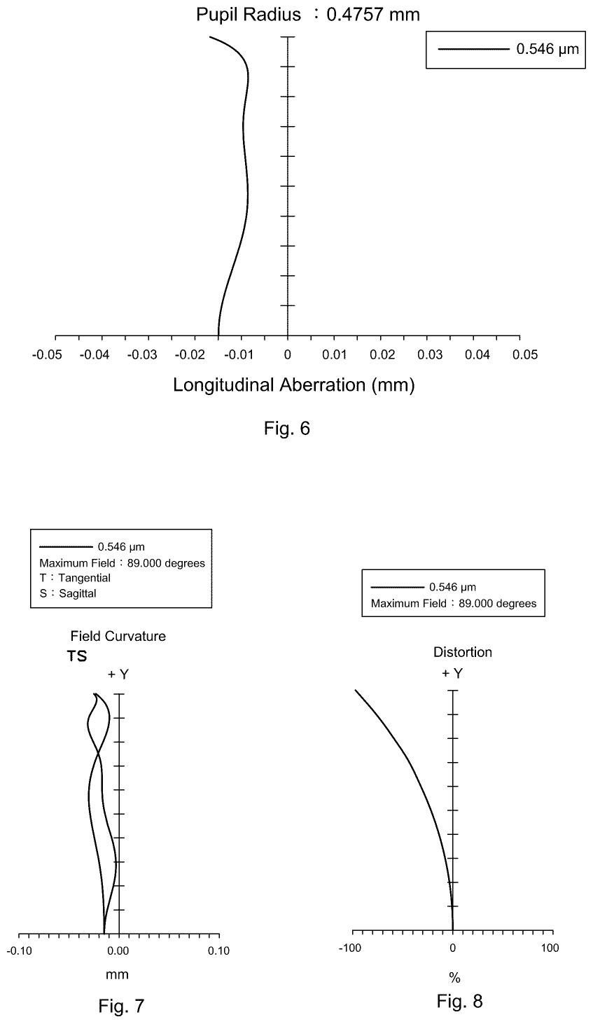

In addition, the wide-angle lens assembly 5 of the fifth embodiment can meet the requirements of optical performance as seen in FIGS. 6-8. It can be seen from FIG. 6 that the longitudinal aberration in the wide-angle lens assembly 5 of the fifth embodiment ranges from −0.02 mm to −0.005 mm. It can be seen from FIG. 7 that the field curvature of tangential direction and sagittal direction in the wide-angle lens assembly 5 of the fifth embodiment ranges from −0.04 mm to 0 mm. It can be seen from FIG. 8 that the distortion in the wide-angle lens assembly 5 of the fifth embodiment ranges from −100% to 0%. It is obvious that the longitudinal aberration, the field curvature and the distortion of the wide-angle lens assembly 5 of the fifth embodiment can be corrected effectively. Therefore, the wide-angle lens assembly 5 of the fifth embodiment is capable of good optical performance.

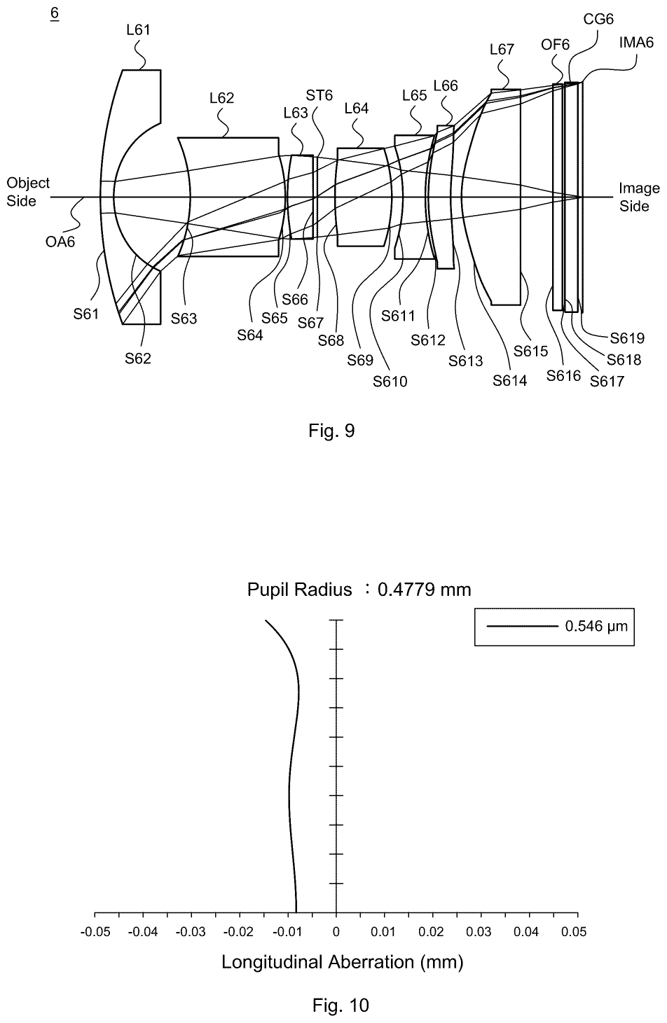

A detailed description of a wide-angle lens assembly in accordance with a sixth embodiment of the invention is as follows. Referring to FIG. 9, the wide-angle lens assembly 6 includes a first lens L61, a second lens L62, a third lens L63, a stop ST6, a fourth lens L64, a fifth lens L65, a sixth lens L66, a seventh lens L67, an optical filter OF6, and a cover glass CG6, all of which are arranged in order from an object side to an image side along an optical axis OA6. In operation, the light from the object side is imaged on an image plane IMA6. According to the foregoing, wherein: the third lens L63 is a biconvex lens, wherein the image side surface S66 is a convex surface and both of the object side surface S65 and image side surface S66 are spherical surfaces; both of the object side surface S616 and image side surface S617 of the optical filter OF6 are plane surfaces; both of the object side surface S618 and image side surface S619 of the cover glass CG6 are plane surfaces; and with the above design of the lenses, stop ST6, and at least one of the conditions (1)-(10) satisfied, the wide-angle lens assembly 6 can have an effective decreased total lens length, an effective increased field of view, an effective increased resolution, and an effective corrected aberration. When the wide-angle lens assembly of the present invention only satisfies condition (7) or condition (8); the first, fourth, fifth and seventh lenses respectively have negative, positive, negative, positive refractive power; the object side surface of the first lens is a convex surface and the image side surface of the first lens is a concave surface; and the image side surface of the sixth lens is a concave surface; the basic operation requirements can be met; or only satisfies condition (7) or condition (8); at least two lenses with positive refractive power are disposed between two lenses with negative refractive power; and at least one lens among the second to seventh lenses being a biconcave lens; the basic operation requirements can be met.

Table 7 shows the optical specification of the wide-angle lens assembly 6 in FIG. 9.

TABLE 7
Effective Focal Length = 2.293 mm F-number = 1.644
Total Lens Length = 15.02 mm Field of View = 150.2 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S61 | 10.00 | 0.41 | 1.82 | 46.57 | −3.69 | L61 |
| S62 | 2.28 | 2.38 | | | | |
| S63 | −4.51 | 2.97 | 1.55 | 56.00 | 17.38 | L62 |
| S64 | −3.77 | 0.07 | | | | |
| S65 | 6.04 | 0.80 | 1.74 | 44.90 | 7.63 | L63 |
| S66 | −96.78 | 0.13 | | | | |
| S67 | ∞ | 0.55 | | | | ST6 |
| S68 | 7.74 | 1.77 | 1.50 | 81.59 | 5.72 | L64 |
| S69 | −4.17 | 0.36 | | | | |
| S610 | −3.78 | 0.69 | 1.67 | 19.24 | −3.71 | L65 |
| S611 | 8.14 | 0.10 | | | | |
| S612 | 4.90 | 0.69 | 1.55 | 56.00 | 62.27 | L66 |
| S613 | 5.43 | 0.34 | | | | |
| S614 | 3.06 | 1.84 | 1.55 | 56.00 | 5.59 | L67 |
| S615 | ∞ | 1.01 | | | | |
| S616 | ∞ | 0.30 | 0.52 | 64.17 | | OF6 |
| S617 | ∞ | 0.08 | | | | |
| S618 | ∞ | 0.40 | 0.52 | 64.17 | | CG6 |
| S619 | ∞ | 0.15 | | | | |

The definition of aspheric surface sag z of each aspheric lens in Table 7 is the same as that of in Table 1, and is not described here again.

In the sixth embodiment, the conic constant k and the aspheric coefficients A, B, C, D, of each aspheric lens are shown in Table 8.

TABLE 8

| Surface | | | | | |
|---|---|---|---|---|---|
| Number | k | A | B | C | D |
| S63 | 0.00E+00 | −5.28E−03 | 1.66E−04 | −7.78E−05 | −3.27E−06 |
| S64 | 0.00E+00 | 3.92E−03 | 1.08E−03 | −1.84E−04 | 6.10E−05 |
| S610 | 0.00E+00 | 1.42E−02 | −6.24E−03 | 4.73E−04 | 7.91E−05 |
| S611 | 0.00E+00 | 1.95E−02 | −4.22E−03 | 2.30E−04 | 0.00E+00 |
| S612 | 0.00E+00 | −7.40E−03 | 2.88E−03 | −3.61E−04 | −2.73E−06 |
| S613 | 0.00E+00 | −1.58E−02 | 2.12E−03 | −1.14E−04 | 3.47E−05 |
| S614 | 0.00E+00 | 3.56E−03 | −9.35E−04 | 1.37E−04 | −5.61E−06 |

Table 9 shows the parameters and condition values for conditions (1)-(10) in accordance with the sixth embodiment of the invention. It can be seen from Table 9 that the wide-angle lens assembly 6 of the sixth embodiment satisfies the conditions (1)-(10).

TABLE 9

| fb | −3.71 | mm | Rc | 3.06 | mm | Ra | 7.74 | mm |
|---|---|---|---|---|---|---|---|---|
| fc | 5.59 | mm | Vdb | 19.24 | | Vdd | 56.00 | |
| BFL | 1.94 | mm | L | 13.09 | mm | | | |
| fb + | −0.66 | mm | Ra/fc | 1.38 | | Vdb/Rc | 6.30 | mm⁻¹ |
| Rc | | | | | | | | |

| | | | | | | |
|---|---|---|---|---|---|---|
| Ra/Vdb | 0.40 | mm | f1/f | −1.61 | Vdd/ | −37.17 |

| | | | | (fc/fb) | |
|---|---|---|---|---|---|
| f/TTL | 0.15 | TTL/BFL | 7.74 | L/f | 5.71 |
| R11/f | 4.36 | | | | |

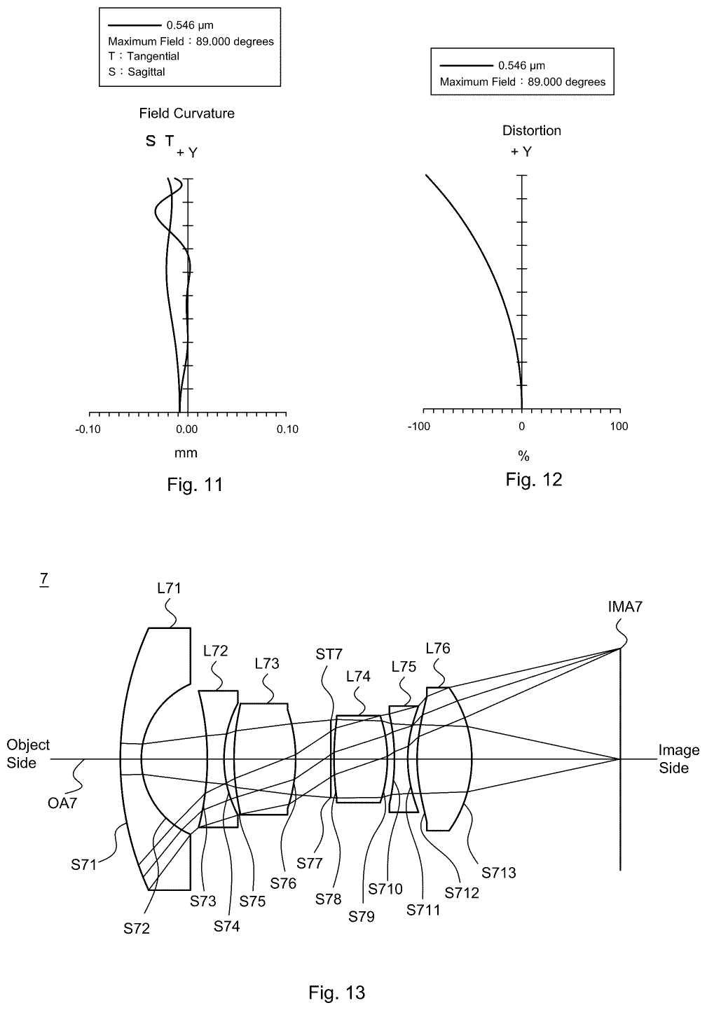

In addition, the wide-angle lens assembly 6 of the sixth embodiment can meet the requirements of optical performance as seen in FIGS. 10-12. It can be seen from FIG. 10 that the longitudinal aberration in the wide-angle lens assembly 6 of the sixth embodiment ranges from −0.015 mm to −0.005 mm. It can be seen from FIG. 11 that the field curvature of tangential direction and sagittal direction in the wide-angle lens assembly 6 of the sixth embodiment ranges from −0.04 mm to 0.01 mm. It can be seen from FIG. 12 that the distortion in the wide-angle lens assembly 6 of the sixth embodiment ranges from −100% to 0%. It is obvious that the longitudinal aberration, the field curvature and the distortion of the wide-angle lens assembly 6 of the sixth embodiment can be corrected effectively. Therefore, the wide-angle lens assembly 6 of the sixth embodiment is capable of good optical performance.

The present invention provides a wide-angle lens assembly including a first lens, a second lens, a third lens, a stop, a fourth lens, a fifth lens, and a sixth lens. The first lens is with negative refractive power. The second lens is with refractive power and includes a concave surface facing an object side. The third lens is with positive refractive power and includes a convex surface facing the object side. The fourth lens is with refractive power. The fifth lens is with refractive power. The sixth lens is with refractive power. The first lens, the second lens, the third lens, the stop, the fourth lens, the fifth lens, and the sixth lens are arranged in order from the object side to an image side along an optical axis. The wide-angle lens assembly satisfies at least one of the following conditions: −70≤R21/d45≤−18; 5 mm²≤(Ra-R21)×d45≤11 mm²; −2.95≤R62/T6≤−2.01; 0.35≤(R11-R12)/TTL≤0.61; 1.86≤BFL/f≤1.99; 0.47≤f/AAG≤0.76; wherein: f is an effective focal length of the wide-angle lens assembly; R11 is a radius of curvature of an object side surface of the first lens; R12 is a radius of curvature of an image side surface of the first lens; R21 is a radius of curvature of an object side surface of the second lens; R62 is a radius of curvature of an image side surface of the sixth lens; d45 is an interval from an image side surface of the lens second closest to the stop and between the stop and the object side to an object side surface of the lens closest to the stop and between the stop and the object side along an optical axis; Ra is a radius of curvature of an object side surface of the lens closest to the stop and between the stop and an image plane; T6 is an interval from an object side surface of the sixth lens to an image side surface of the sixth length along the optical axis; TTL is an interval from the object side surface of the first lens to the image plane along the optical axis; BFL is an interval from an image side surface of the lens closest to the image plane to the image plane along the optical axis; and AAG is a sum of air intervals between the first lens and the lens closest to the image plane along the optical axis. A wide-angle lens assembly of the present invention is a preferred embodiment of the present invention when the wide-angle lens assembly satisfies the above features and at least one of the above conditions.

Referring to Table 10, Table 11, Table 13, Table 14, Table 16, Table 17, Table 19, and Table 20, wherein Table 10, Table 13, Table 16, and Table 19 show optical specification in accordance with a seventh, an eighth, a ninth, and a tenth embodiments of the invention, respectively, and Table 11, Table 14, Table 17, and Table 20 show aspheric coefficients of each aspheric lens in Table 10, Table 13, Table 16, and Table 19, respectively. The aspheric surface sag z of each aspheric lens in the following embodiments can be calculated by the following formula: z=ch²/{1+[1−(k+1)c²h²]^{1/2}}+Ah⁴+Bh⁶+Ch⁸, where c is curvature, h is the vertical distance from the lens surface to the optical axis, k is conic constant, A, B, and C are aspheric coefficients, and the value of the aspheric coefficient A, B, and C are presented in scientific notation, such as 2.00E-03 for 2.00×10⁻³.

FIGS. 13, 17, 21, and 25 are lens layout and optical path diagrams of the lens assemblies in accordance with the seventh, eighth, ninth, and tenth embodiments of the invention, respectively.

The first lenses L71, L81, L91, L101 are meniscus lenses with negative refractive power, wherein the object side surfaces S71, S81, S91, S101 are convex surfaces, the image side surfaces S72, S82, S92, S102 are concave surfaces, and both of the object side surfaces S71, S81, S91, S101 and image side surfaces S72, S82, S92, S102 are spherical surfaces.

The second lenses L72, L82, L92, L102 are biconcave lenses with negative refractive power, wherein the object side surfaces S73, S83, S93, S103 are concave surfaces, the image side surfaces S74, S84, S94, S104 are concave surfaces, and both of the object side surfaces S73, S83, S93, S103 and image side surfaces S74, S84, S94, S104 are aspheric surfaces.

The third lenses L73, L83, L93, L103 are biconvex lenses with positive refractive power, wherein the object side surfaces S75, S85, S95, S105 are convex surfaces, the image side surfaces S76, S86, S96, S106 are convex surfaces, and both of the object side surfaces S75, S85, S95, S105 and image side surfaces S76, S86, S96, S106 are aspheric surfaces.

The fourth lenses L74, L84, L94, L104 are biconvex lenses with positive refractive power, wherein the object side surfaces S78, S88, S98, S108 are convex surfaces, the image side surfaces S79, S89, S99, S109 are convex surfaces, and both of the object side surfaces S78, S88, S98, S108 and image side surfaces S79, S89, S99, S109 are spherical surfaces.

The fifth lenses L75, L85, L95, L105 are biconcave lenses with negative refractive power, wherein the object side surfaces S710, S810, S910, S1010 are concave surfaces, the image side surfaces S711, S811, S911, S1011 are concave surfaces, and both of the object side surfaces S710, S810, S910, S1010 and image side surfaces S711, S811, S911, S1011 are aspheric surfaces.

The sixth lenses L76, L86, L96, L106 are biconvex lenses with positive refractive power, wherein the object side surfaces S712, S812, S912, S1012 are convex surfaces, the image side surfaces S713, S813, S913, S1013 are convex surfaces, and both of the object side surfaces S712, S812, S912, S1012 and image side surfaces S713, S813, S913, S1013 are aspheric surfaces.

In addition, the wide-angle lens assemblies 7, 8, 9, and 10 satisfy at least one of the following conditions (11)-(19):

$$- 70 \leq R 21 / d 45 \leq - 18 ; \qquad ( 11 )$$

$$5 {mm}^{2} \leq ( R a - R 21 ) \times d 45 \leq 11 {mm}^{2} \qquad ( 12 )$$

$$2.5 mm \leq Ra / Nd 4 \leq 15 mm ; \qquad ( 13 )$$

$$5 \leq Ra / d 67 \leq 62 ; \qquad ( 14 )$$

$$2 mm \leq Ra + R d \leq 19 mm ; \qquad ( 15 )$$

$$- 2.9 \; 5 \leq R 62 / T 6 \leq - 2 \text{.01} ; \qquad ( 16 )$$

$$0.35 \leq ( R 11 - R 12 ) / TTL \leq 0 \text{.61} ; \qquad ( 17 )$$

$$1. 86 \leq BFL / f \leq 1 \text{.99} ; \qquad ( 18 )$$

$$0.47 \leq f / AAG \leq 0 \text{.76} ; \qquad ( 19 )$$

Wherein: f is an effective focal length of the wide-angle lens assemblies 7, 8, 9, 10 for the seventh to tenth embodiments; R11 is a radius of curvature of the object side surfaces S71, S81, S91, S101 of the first lenses L71, L81, L91, L101 for the seventh to tenth embodiments; R12 is a radius of curvature of the image side surfaces S72, S82, S92, S102 of the first lenses L71, L81, L91, L101 for the seventh to tenth embodiments; R21 is a radius of curvature of the object side surfaces S73, S83, S93, S103 of the second lenses L72, L82, L92, L102 for the seventh to tenth embodiments; R62 is a radius of curvature of the image side surfaces S713, S813, S913, S103 of the sixth lenses L76, L86, L96, L106 for the seventh to tenth embodiments; d45 is an interval from the image side surfaces S74, S84, S94, S104 of the lenses L72, L82, L92, L102 second closest to the stops ST7, ST8, ST9, ST10 and between the stops ST7, ST8, ST9, ST10 and the object side to the object side surfaces S75, S85, S95, S105 of the lenses L73, L83, L93, L103 closest to the stops ST7, ST8, ST9, ST10 along the optical axes OA7, OA8, OA9, OA10 for the seventh to tenth embodiments; Ra is a radius of curvature of the object side surfaces S78, S88, S98, S108 of the lenses L74, L84, L94, L104 closest to the stops ST7, ST8, ST9, ST10 and between the stops ST7, ST8, ST9, ST10 and the image planes IMA7, IMA8, IMA9, IMA10 for the seventh to tenth embodiments; T6 is an interval from the object side surfaces S712, S812, S912, S1012 of the sixth lenses L76, L86, L96, L106 to the image side surfaces S713, S813, S913, S1013 of the sixth lenses L76, L86, L96, L106 along the optical axes OA7, OA8, OA9, OA10 for the seventh to tenth embodiments; TTL is an interval from the object side surfaces S71, S81, S91, S101 of the first lenses L71, L81, L91, L101 to the image planes IMA7, IMA8, IMA9, IMA10 along the optical axes OA7, OA8, OA9, OA10 for the seventh to tenth embodiments; BFL is an interval from the image side surfaces S713, S813, S913, S1013 of the lenses L76, L86, L96, L106 closest to the image planes IMA7, IMA8, IMA9, IMA10 to the image planes IMA7, IMA8, IMA9, IMA10 along the optical axes OA7, OA8, OA9, OA10 for the seventh to tenth embodiments; AAG is a sum of air intervals between the first lenses L71, L81, L91, L101 and the lenses L76, L86, L96, L106 closest to the image planes IMA7, IMA8, IMA9, IMA10 along the optical axes OA7, OA8, OA9, OA10 for the seventh to tenth embodiments; Nd4 is a refractive index of the lenses L74, L84, L94, L104 closest to the stops ST7, ST8, ST9, ST10 and between the stops ST7, ST8, ST9, ST10 and the image planes IMA7, IMA8, IMA9, IMA10 for the seventh to tenth embodiments; d67 is an interval from the image side surfaces S76, S86, S96, S106 of the lenses L73, L83, L93, L103 closest to the stops ST7, ST8, ST9, ST10 and between the object side and the stops ST7, ST8, ST9, ST10 to the stops ST7, ST8, ST9, ST10 along the optical axes OA7, OA8, OA9, OA10 for the seventh to tenth embodiments; and Rd is radius of curvature of the object side surfaces S710, S810, S910, S1010 of the lenses L75, L85, L95, L105 second closest to the image planes IMA7, IMA8, IMA9, IMA10 for the seventh to tenth embodiments. Making the wide-angle lens assemblies 7, 8, 9, 10 effectively increasing the field of view, effectively shortening the total lens length, effectively increasing the resolution, effectively resisting environment temperature change, and effectively correcting aberration.

When the condition (11): −70≤R21/d45≤−18 is satisfied, the total lens length can be effectively decreased, the light intensity of the peripheral image can be effectively increased, and the manufacturing yield of the lens can be effectively increased. When the condition (12): 5 mm²≤(Ra-R21)×d45≤11 mm² is satisfied, the field curvature can be effectively decreased, the image quality degradation caused by high temperature environment can be effectively compensated, and the manufacturing yield of the lens can be effectively increased. When the condition (13): 2.5 mm≤Ra/Nd4≤15 mm is satisfied, the longitudinal chromatic aberration can be effectively decreased and the manufacturing yield of the wide-angle lens assembly can be effectively increased. When the condition (14): 5≤Ra/d67≤62 is satisfied, the off-axis aberration can be effectively decreased and the astigmatism can be effectively decreased. When the condition (15): 2 mm≤Ra+Rd≤19 mm is satisfied, the off-axis aberration can be effectively decreased and the astigmatism can be effectively decreased. When the condition (16): −2.95≤R62/T6≤−2.01 is satisfied, the total lens length can be effectively decreased. When the condition (17): 0.35≤(R11-R12)/TTL≤0.61 is satisfied, the manufacturing yield of the lens can be effectively increased. When the condition (18): 1.86≤BFL/f≤1.99 is satisfied, the total lens length can be effectively decreased. When the condition (19): 0.47≤f/AAG≤0.76 is satisfied, the total lens length can be effectively decreased.

A detailed description of a wide-angle lens assembly in accordance with a seventh embodiment of the invention is as follows. Referring to FIG. 13, the wide-angle lens assembly 7 includes a first lens L71, a second lens L72, a third lens L73, a stop ST7, a fourth lens L74, a fifth lens L75, and a sixth lens L76, all of which are arranged in order from an object side to an image side along an optical axis OA7. In operation, the light from the object side is imaged on an image plane IMA7. Using the above lenses, stop ST7, and at least one of the conditions (11)-(19) satisfied, the wide-angle lens assembly 7 can have an effective increased field of view, an effective decreased total lens length, an effective increased resolution, an effective resisted environment temperature change, and an effective corrected aberration. The wide-angle lens assembly of the present invention can meet the basic operation requirements when it only satisfies condition (11), condition (12), condition (13), condition (14), condition (15), condition (16), condition (17), condition (18), or condition (19), and the refractive surface shape characteristics of the independent claim.

Table 10 shows the optical specification of the wide-angle lens assembly 7 in FIG. 13.

TABLE 10
Effective Focal Length = 2.27 mm F-number = 2.4
Total Lens Length = 15.01 mm Field of View = 177.0 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S71 | 9.54 | 0.63 | 1.88 | 41 | −3.913 | L71 |
| S72 | 2.46 | 1.99 | | | | |
| S73 | −8.80 | 0.50 | 1.54 | 60 | −4.674 | L72 |
| S74 | 3.63 | 0.30 | | | | |
| S75 | 6.54 | 1.85 | 1.61 | 26 | 4.586 | L73 |
| S76 | −4.43 | 1.05 | | | | |
| S77 | ∞ | 0.10 | | | | ST7 |
| S78 | 9.56 | 1.60 | 1.75 | 50 | 3.971 | L74 |
| S79 | −4.04 | 0.22 | | | | |
| S710 | −7.12 | 0.39 | 1.65 | 20 | −3.469 | L75 |
| S711 | 3.43 | 0.28 | | | | |
| S712 | 4.41 | 1.65 | 1.54 | 60 | 4.078 | L76 |
| S713 | −3.85 | 4.45 | | | | |

In the seventh embodiment, the conic constant k and the aspheric coefficients A, B, C, of each aspheric lens are shown in Table 11.

TABLE 11

| Surface | | | | |
|---|---|---|---|---|
| Number | k | A | B | C |
| S73 | 0.00E+00 | −1.63E−03 | 8.31E−05 | 0.00E+00 |
| S74 | −3.15E+00 | 8.29E−03 | −7.46E−05 | 0.00E+00 |
| S75 | 0.00E+00 | −2.72E−03 | −5.72E−05 | 0.00E+00 |
| S76 | 0.00E+00 | 1.67E−03 | −1.04E−04 | 3.73E−05 |
| S710 | 1.12E+01 | −2.85E−03 | −2.06E−04 | 2.48E−04 |
| S711 | −2.42E+00 | −6.91E−03 | 1.91E−03 | −1.82E−04 |
| S712 | −3.98E+00 | −8.77E−03 | 1.25E−03 | −6.29E−05 |
| S713 | −7.51E−01 | −2.70E−03 | −2.44E−04 | 0.00E+00 |

Table 12 shows the parameters and condition values for conditions (11)-(19) in accordance with the seventh embodiment of the invention. It can be seen from Table 12 that the wide-angle lens assembly 7 of the seventh embodiment satisfies the conditions (11)-(19).

TABLE 12

| d45 | 0.30 mm | Ra | 9.56 | mm | T6 | 1.65 mm |
|---|---|---|---|---|---|---|
| BFL | 4.45 mm | AAG | 3.94 | mm | Nd4 | 1.75 |
| d67 | 1.05 mm | Rd | −7.12 | mm | | |
| R21/d45 | −29.21 | (Ra − | 5.53 | mm² | Ra/Nd4 | 5.47 mm |
| | | R21) × d45 | | | | |
| Ra/d67 | 9.09 | Ra + Rd | 2.45 | mm | R62/T6 | −2.32 |
| (R11 − | 0.47 | BFL/f | 1.96 | | f/AAG | 0.58 |
| R12)/TTL | | | | | | |

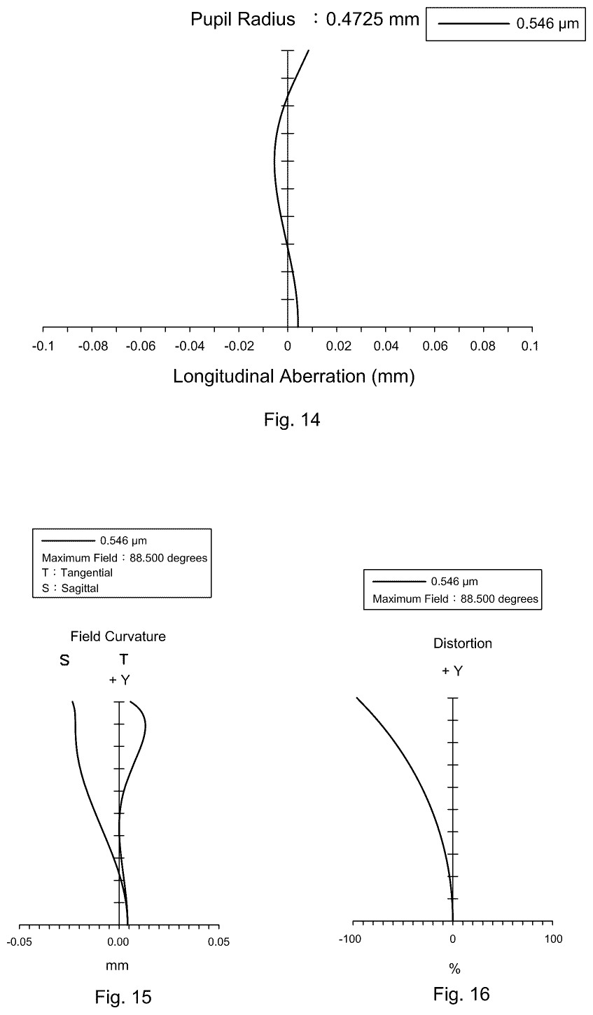

In addition, the wide-angle lens assembly 7 of the seventh embodiment can meet the requirements of optical performance as seen in FIGS. 14-16. It can be seen from FIG. 14 that the longitudinal aberration in the wide-angle lens assembly 7 of the seventh embodiment ranges from −0.01 mm to 0.01 mm. It can be seen from FIG. 15 that the field curvature of tangential direction and sagittal direction in the wide-angle lens assembly 7 of the seventh embodiment ranges from −0.025 mm to 0.015 mm. It can be seen from FIG. 16 that the distortion in the wide-angle lens assembly 7 of the seventh embodiment ranges from −100% to 0%. It is obvious that the longitudinal aberration, the field curvature and the distortion of the wide-angle lens assembly 7 of the seventh embodiment can be corrected effectively. Therefore, the wide-angle lens assembly 7 of the seventh embodiment is capable of good optical performance.

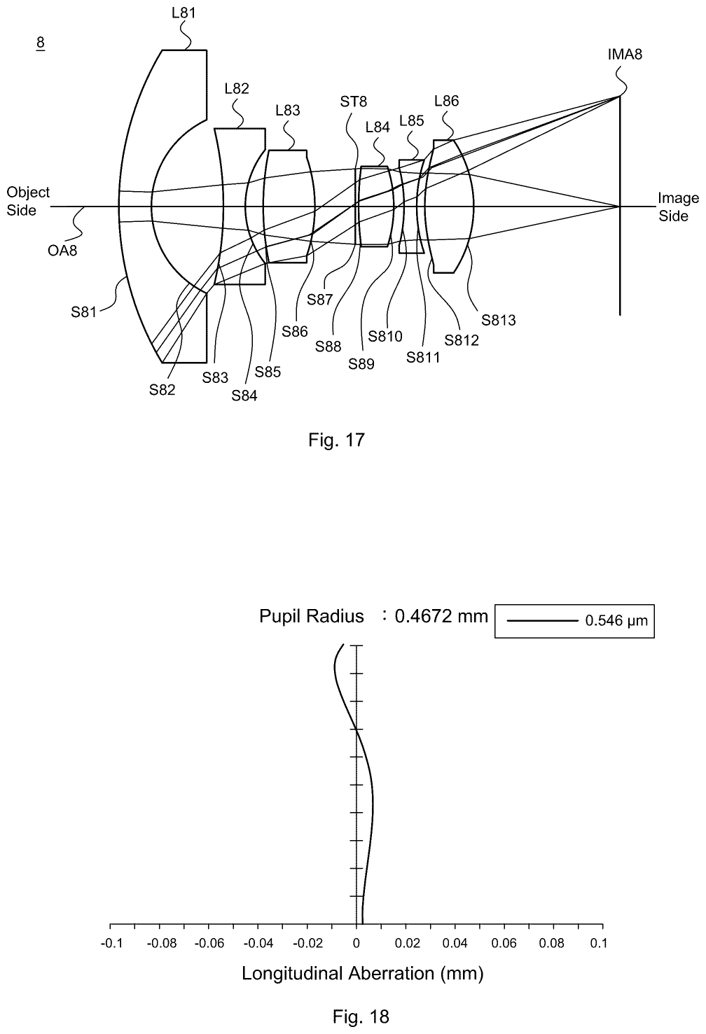

A detailed description of a wide-angle lens assembly in accordance with an eighth embodiment of the invention is as follows. Referring to FIG. 17, the wide-angle lens assembly 8 includes a first lens L81, a second lens L82, a third lens L83, a stop ST8, a fourth lens L84, a fifth lens L85, and a sixth lens L86, all of which are arranged in order from an object side to an image side along an optical axis OA8. In operation, the light from the object side is imaged on an image plane IMA8. Using the above lenses, stop ST8, and at least one of the conditions (11)-(19) satisfied, the wide-angle lens assembly 8 can have an effective increased field of view, an effective decreased total lens length, an effective increased resolution, an effective resisted environment temperature change, and an effective corrected aberration.

Table 13 shows the optical specification of the wide-angle lens assembly 8 in FIG. 17.

TABLE 13
Effective Focal Length = 2.24 mm F-number = 2.4
Total Lens Length = 15.00 mm Field of View = 177.0 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S81 | 9.27 | 0.91 | 1.88 | 40 | −4.957 | L81 |
| S82 | 2.84 | 2.21 | | | | |
| S83 | −9.75 | 0.66 | 1.54 | 56 | −4.144 | L82 |
| S84 | 2.99 | 0.53 | | | | |
| S85 | 6.79 | 1.55 | 1.60 | 26 | 4.794 | L83 |
| S86 | −4.63 | 1.21 | | | | |
| S87 | ∞ | 0.10 | | | | ST8 |
| S88 | 9.39 | 1.05 | 1.75 | 52 | 3.789 | L84 |
| S89 | −3.90 | 0.32 | | | | |
| S810 | −4.54 | 0.37 | 1.65 | 20 | −3.288 | L85 |
| S811 | 4.26 | 0.25 | | | | |
| S812 | 4.39 | 1.47 | 1.54 | 60 | 3.913 | L86 |
| S813 | −3.63 | 4.38 | | | | |

In the eighth embodiment, the conic constant k and the aspheric coefficients A, B, C, of each aspheric lens are shown in Table 14.

TABLE 14

| Surface | | | | |
|---|---|---|---|---|
| Number | k | A | B | C |
| S83 | 0.00E+00 | −4.67E−04 | 1.18E−04 | 0.00E+00 |
| S84 | 9.31E−01 | −1.97E−03 | −2.19E−04 | 0.00E+00 |
| S85 | 0.00E+00 | −4.70E−03 | −3.12E−04 | 0.00E+00 |
| S86 | 0.00E+00 | −2.17E−04 | −2.17E−04 | −6.67E−05 |
| S810 | 5.91E+00 | 1.30E−02 | −1.23E−03 | 4.07E−04 |
| S811 | −4.18E−03 | −2.74E−03 | 1.13E−03 | −4.23E−04 |
| S812 | −1.28E+01 | 6.98E−04 | 1.30E−04 | −2.86E−05 |
| S813 | −4.00E−01 | −1.31E−03 | −2.23E−04 | 0.00E+00 |

Table 15 shows the parameters and condition values for conditions (11)-(19) in accordance with the eighth embodiment of the invention. It can be seen from Table 15 that the wide-angle lens assembly 8 of the eighth embodiment satisfies the conditions (11)-(19).

TABLE 15

| d45 | 0.53 mm | Ra | 9.39 | mm | T6 | 1.47 mm |
|---|---|---|---|---|---|---|
| BFL | 4.38 mm | AAG | 4.61 | mm | Nd4 | 1.75 |
| d67 | 1.21 mm | Rd | −4.54 | mm | | |
| R21/d45 | −18.37 | (Ra − | 10.16 | mm² | Ra/Nd4 | 5.37 mm |
| | | R21) × d45 | | | | |
| Ra/d67 | 7.77 | Ra + Rd | 4.85 | mm | R62/T6 | −2.46 |
| (R11 − | 0.43 | BFL/f | 1.95 | | f/AAG | 0.49 |
| R12)/TTL | | | | | | |

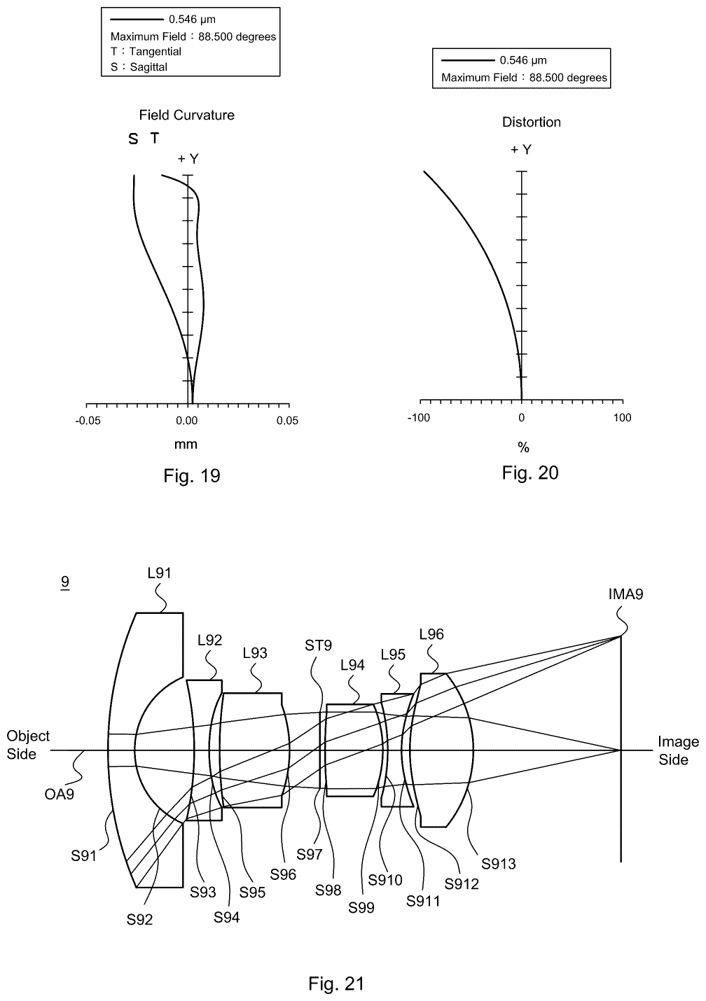

In addition, the wide-angle lens assembly 8 of the eighth embodiment can meet the requirements of optical performance as seen in FIGS. 18-20. It can be seen from FIG. 18 that the longitudinal aberration in the wide-angle lens assembly 8 of the eighth embodiment ranges from −0.01 mm to 0.01 mm. It can be seen from FIG. 19 that the field curvature of tangential direction and sagittal direction in the wide-angle lens assembly 8 of the eighth embodiment ranges from −0.03 mm to 0.01 mm. It can be seen from FIG. 20 that the distortion in the wide-angle lens assembly 8 of the eighth embodiment ranges from −100% to 0%. It is obvious that the longitudinal aberration, the field curvature and the distortion of the wide-angle lens assembly 8 of the eighth embodiment can be corrected effectively. Therefore, the wide-angle lens assembly 8 of the eighth embodiment is capable of good optical performance.

A detailed description of a wide-angle lens assembly in accordance with a ninth embodiment of the invention is as follows. Referring to FIG. 21, the wide-angle lens assembly 9 includes a first lens L91, a second lens L92, a third lens L93, a stop ST9, a fourth lens L94, a fifth lens L95, and a sixth lens L96, all of which are arranged in order from an object side to an image side along an optical axis OA9. In operation, the light from the object side is imaged on an image plane IMA9. Using the above lenses, stop ST9, and at least one of the conditions (11)-(19) satisfied, the wide-angle lens assembly 9 can have an effective increased field of view, an effective decreased total lens length, an effective increased resolution, an effective resisted environment temperature change, and an effective corrected aberration.

Table 16 shows the optical specification of the wide-angle lens assembly 9 in FIG. 21.

TABLE 16
Effective Focal Length = 2.29 mm F-number = 2.4
Total Lens Length = 14.95 mm Field of View = 177.0 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S91 | 10.04 | 0.78 | 1.80 | 41 | −3.907 | L91 |
| S92 | 2.31 | 1.74 | | | | |
| S93 | −8.15 | 0.43 | 1.54 | 56 | −5.489 | L92 |
| S94 | 4.78 | 0.30 | | | | |
| S95 | 9.62 | 2.04 | 1.60 | 26 | 4.834 | L93 |
| S96 | −3.87 | 0.89 | | | | |
| S97 | ∞ | 0.15 | | | | ST9 |
| S98 | 13.47 | 1.67 | 1.75 | 50 | 3.870 | L94 |
| S99 | −3.52 | 0.15 | | | | |
| S910 | −6.54 | 0.40 | 1.65 | 20 | −3.311 | L95 |
| S911 | 3.34 | 0.24 | | | | |
| S912 | 4.30 | 1.84 | 1.54 | 56 | 4.058 | L96 |
| S913 | −3.83 | 4.31 | | | | |

In the ninth embodiment, the conic constant k and the aspheric coefficients A, B, C, of each aspheric lens are shown in Table 17.

TABLE 17

| Surface | | | | |
|---|---|---|---|---|
| Number | k | A | B | C |
| S93 | 0.00E+00 | 3.40E−03 | −4.43E−04 | 0.00E+00 |
| S94 | −8.06E+00 | 1.57E−02 | 1.25E−04 | 0.00E+00 |
| S95 | 0.00E+00 | −4.08E−03 | 4.92E−04 | 0.00E+00 |
| S96 | 0.00E+00 | 2.68E−03 | −4.40E−04 | 8.12E−05 |
| S910 | 1.29E+01 | −2.72E−03 | 3.14E−04 | 4.56E−04 |
| S911 | −3.24E+00 | −2.54E−03 | 1.08E−03 | −1.76E−04 |
| S912 | −1.79E+00 | −1.09E−02 | 1.41E−03 | −8.67E−05 |
| S813 | −8.52E−02 | −2.13E−03 | −1.67E−04 | 0.00E+00 |

Table 18 shows the parameters and condition values for conditions (11)-(19) in accordance with the ninth embodiment of the invention. It can be seen from Table 18 that the wide-angle lens assembly 9 of the ninth embodiment satisfies the conditions (11)-(19).

TABLE 18

| d45 | 0.30 mm | Ra | 13.47 | mm | T6 | 1.84 mm |
|---|---|---|---|---|---|---|
| BFL | 4.31 mm | AAG | 3.47 | mm | Nd4 | 1.75 |
| d67 | 0.89 mm | Rd | −6.54 | mm | | |
| R21/d45 | −27.16 | (Ra − | 6.49 | mm² | Ra/Nd4 | 7.70 mm |
| | | R21) × d45 | | | | |
| Ra/d67 | 15.19 | Ra + Rd | 6.93 | mm | R62/T6 | −2.08 |
| (R11 − | 0.52 | BFL/f | 1.88 | | f/AAG | 0.66 |
| R12)/TTL | | | | | | |

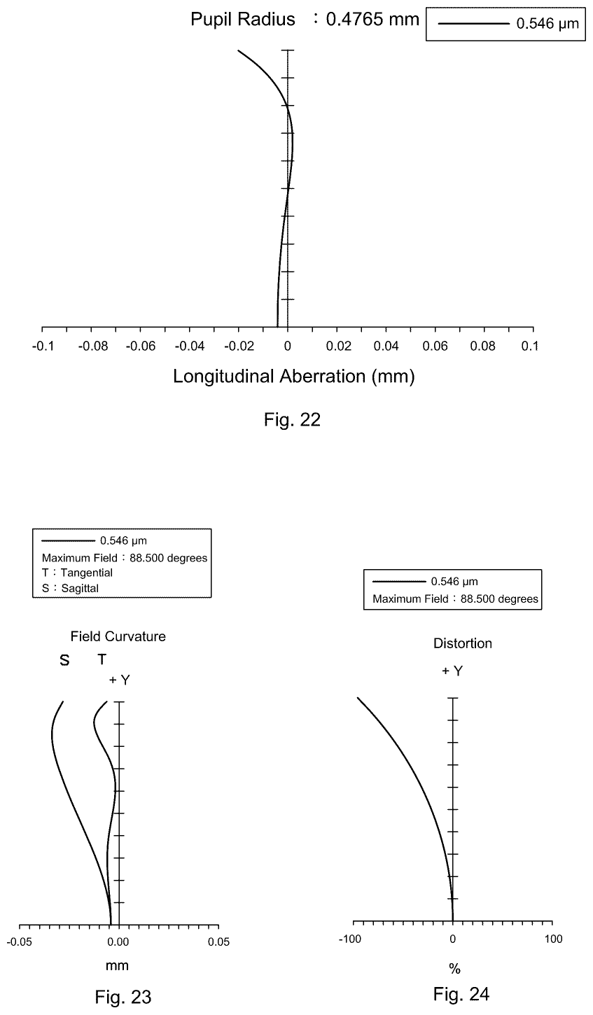

In addition, the wide-angle lens assembly 9 of the ninth embodiment can meet the requirements of optical performance as seen in FIGS. 22-24. It can be seen from FIG. 22 that the longitudinal aberration in the wide-angle lens assembly 9 of the ninth embodiment ranges from −0.02 mm to 0.01 mm. It can be seen from FIG. 23 that the field curvature of tangential direction and sagittal direction in the wide-angle lens assembly 9 of the ninth embodiment ranges from −0.035 mm to 0 mm. It can be seen from FIG. 24 that the distortion in the wide-angle lens assembly 9 of the ninth embodiment ranges from −100% to 0%. It is obvious that the longitudinal aberration, the field curvature and the distortion of the wide-angle lens assembly 9 of the ninth embodiment can be corrected effectively. Therefore, the wide-angle lens assembly 9 of the ninth embodiment is capable of good optical performance.

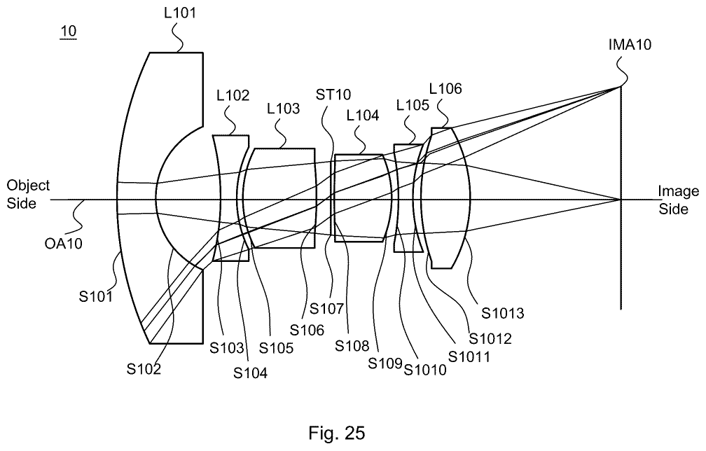

A detailed description of a wide-angle lens assembly in accordance with a tenth embodiment of the invention is as follows. Referring to FIG. 25, the wide-angle lens assembly 10 includes a first lens L101, a second lens L102, a third lens L103, a stop ST10, a fourth lens L104, a fifth lens L105, and a sixth lens L106, all of which are arranged in order from an object side to an image side along an optical axis OA10. In operation, the light from the object side is imaged on an image plane IMA10. Using the above lenses, stop ST10, and at least one of the conditions (11)-(19) satisfied, the wide-angle lens assembly 10 can have an effective increased field of view, an effective decreased total lens length, an effective increased resolution, an effective resisted environment temperature change, and an effective corrected aberration.

Table 19 shows the optical specification of the wide-angle lens assembly 10 in FIG. 25.

TABLE 19
Effective Focal Length = 2.28 mm F-number = 2.4
Total Lens Length = 15.04 mm Field of View = 177.0 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S101 | 9.96 | 1.16 | 1.88 | 40 | −3.647 | L101 |
| S102 | 2.30 | 1.93 | | | | |
| S103 | −8.68 | 0.46 | 1.54 | 56 | −3.997 | L102 |
| S104 | 2.94 | 0.19 | | | | |
| S105 | 3.13 | 2.21 | 1.60 | 26 | 3.877 | L103 |
| S106 | −6.87 | 0.42 | | | | |
| S107 | ∞ | 0.10 | | | | ST10 |
| S108 | 25.68 | 1.72 | 1.75 | 56 | 3.802 | L104 |
| S109 | −3.13 | 0.20 | | | | |
| S1010 | −7.71 | 0.42 | 1.65 | 20 | −3.619 | L105 |
| S1011 | 3.52 | 0.24 | | | | |
| S1012 | 3.95 | 1.48 | 1.54 | 56 | 4.063 | L106 |
| S1013 | −4.32 | 4.50 | | | | |

In the tenth embodiment, the conic constant k and the aspheric coefficients A, B, C, of each aspheric lens are shown in Table 20.

TABLE 20

| Surface | | | | |
|---|---|---|---|---|
| Number | k | A | B | C |
| S103 | 0.00E+00 | −4.06E−03 | 3.12E−04 | 0.00E+00 |
| S104 | 6.36E−02 | −3.40E−03 | −2.39E−03 | 0.00E+00 |
| S105 | 0.00E+00 | 2.30E−03 | −1.18E−03 | 0.00E+00 |
| S106 | 0.00E+00 | 1.49E−02 | 2.02E−03 | 4.31E−04 |
| S1010 | 9.98E+00 | 1.02E−03 | −5.60E−04 | 1.35E−04 |
| S1011 | −2.06E+00 | −6.89E−03 | 1.46E−03 | −1.28E−04 |
| S1012 | −6.86E+00 | −3.10E−03 | 4.63E−04 | −2.16E−05 |
| S1013 | −9.57E−01 | −2.62E−03 | −1.11E−04 | 0.00E+00 |

Table 21 shows the parameters and condition values for conditions (11)-(19) in accordance with the tenth embodiment of the invention. It can be seen from Table 21 that the wide-angle lens assembly 10 of the tenth embodiment satisfies the conditions (11)-(19).

TABLE 21

| d45 | 0.19 mm | Ra | 25.68 | mm | T6 | 1.48 | mm |
|---|---|---|---|---|---|---|---|
| BFL | 4.50 mm | AAG | 3.09 | mm | Nd4 | 1.75 | |
| d67 | 0.42 mm | Rd | −7.71 | mm | | | |
| R21/d45 | −45.50 | (Ra − | 6.56 | mm² | Ra/Nd4 | 14.68 | mm |
| | | R21) × | | | | | |
| | | d45 | | | | | |

| Ra/d67 | 60.72 | Ra + Rd | 17.97 | mm | R62/T6 | −2.92 |
|---|---|---|---|---|---|---|
| (R11 − | 0.51 | BFL/f | 1.98 | | f/AAG | 0.74 |
| R12)/TTL | | | | | | |

It should be noted that, the above fourth to sixth embodiments may also satisfy part or all of the above conditions (11)-(19) and the above seventh to tenth embodiments may also satisfy part or all of the above conditions (1)-(10), even though it is not explicitly showed in the table for condition values, these condition values can be obtained by calculation based on the optical specification disclosed in each embodiment.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wide-angle lens assembly comprising:
a first lens which is with negative refractive power;
a second lens which is with refractive power and comprises a concave surface facing an object side;
a third lens which is with positive refractive power;
a fourth lens which is with refractive power;
a fifth lens which is with refractive power; and
a sixth lens which is with refractive power;
wherein the first lens, the second lens, the third lens, the fourth lens, the fifth lens, and the sixth lens are arranged in order from the object side to an image side along an optical axis;
wherein the wide-angle lens assembly satisfies at least one of following conditions:
$$- 70 \leq R 21 / d 45 \leq - 18 ;$$
$$5 {mm}^{2} \leq ( R a - R 21 ) \times d 45 \leq 11 {mm}^{2} ;$$
$$- 2.9 \; 5 \leq R 62 / T 6 \leq - 2 \text{.01} ;$$
$$0.35 \leq ( R 11 - R 12 ) / TTL \leq 0 \text{.61} ;$$
$$1. 86 \leq BFL / f \leq 1 \text{.99} ;$$
$$0.47 \leq f / AAG \leq 0 \text{.76} ;$$
$$4.5 < L / f < 6.9 ;$$
$$3.4 < R 11 / f < 5.5 ;$$
wherein f is an effective focal length of the wide-angle lens assembly, R11 is a radius of curvature of an object side surface of the first lens, R12 is a radius of curvature of an image side surface of the first lens, R21 is a radius of curvature of an object side surface of the second lens, R62 is a radius of curvature of an image side surface of the sixth lens, d45 is an interval from an image side surface of the lens second closest to a stop and between the stop and the object side to an object side surface of the lens closest to the stop and between the stop and the object side along the optical axis, Ra is a radius of curvature of an object side surface of the lens closest to the stop and between the stop and an image plane, T6 is an interval from an object side surface of the sixth lens to an image side surface of the sixth lens along the optical axis, TTL is an interval from the object side surface of the first lens to the image plane along the optical axis, BFL is an interval from an image side surface of the lens closest to the image plane to the image plane along the optical axis, AAG is a sum of air intervals between the first lens and the lens closest to the image plane along the optical axis, and L is an interval from the object side surface of the first lens to the image side surface of the lens closest to the image plane along the optical axis.

2. The wide-angle lens assembly as claimed in claim 1, wherein the wide-angle lens assembly satisfies at least one of following conditions:
$$2.5 mm \leq Ra / Nd 4 \leq 15 mm ;$$
$$5 \leq Ra / d 67 \leq 62 ;$$
$$2 mm \leq Ra + R d \leq 19 mm ;$$
$$- 1 mm \leq fb + Rc \leq 2 mm ;$$
$$0.14 < Ra / fc < 6 \text{.62} ;$$
$$3 {mm}^{- 1} < Vdb / Rc < 7 {mm}^{- 1} ;$$
$$0.14 mm < Ra / Vdb < 1.34 mm ;$$
$$- 2.3 < f 1 / f < - 1.5 ;$$
$$- 38.3 < Vdd / ( fc / fb ) < - 15.2 ;$$
$$0.14 < f / TTL < 0.18 ;$$
$$3.1 < TTL / BFL < 8.1 ;$$
wherein Ra is the radius of curvature of the object side surface of the lens closest to the stop and between the stop and the image plane, Rd is a radius of curvature of an object side surface of the lens second closest to the image plane, Nd4 is a refractive index of the lens closest to the stop and between the stop and the image plane, d67 is an interval from an image side surface of the lens closest to the stop and between the object side and the stop to the stop along the optical axis, f is the effective focal length of the wide-angle lens assembly, f1 is an effective focal length of the first lens, fb is an effective focal length of the lens second closest to the stop and between the stop and the image plane, fc is an effective focal length of the lens closest to the image plane, TTL is the interval from the object side surface of the first lens to the image plane along the optical axis, BFL is the interval from the image side surface of the lens closest to the image plane to the image plane along the optical axis, L is the interval from the object side surface of the first lens to the image side surface of the lens closest to the image plane along the optical axis, Rc is a radius of curvature of an object side surface of the lens closest to the image plane, Vdb is an Abbe number of the lens second closest to the stop and between the stop and the image plane, Vdd is an Abbe number of the lens second closest to the image plane, and R11 is the radius of curvature of the object side surface of the first lens.

3. The wide-angle lens assembly as claimed in claim 2, further comprising a seventh lens disposed between the sixth lens and the image side, wherein:
the first lens is a meniscus lens and comprises a convex surface facing the object side and a concave surface facing the image side;
the second lens is a meniscus lens with positive refractive power and further comprises a convex surface facing the image side;
the third lens comprises a convex surface facing the object side;
the fourth lens is a biconvex lens with positive refractive power and comprises a convex surface facing the object side and another convex surface facing the image side;
the fifth lens is a biconcave lens with negative refractive power and comprises a concave surface facing the object side and another concave surface facing the image side;
the sixth lens is a meniscus lens with positive refractive power and comprises a convex surface facing the object side and a concave surface facing the image side; and
the seventh lens is a plano-convex lens with positive refractive power and comprises a convex surface facing the object side and a plane surface facing the image side.

4. The wide-angle lens assembly as claimed in claim 3, wherein the third lens is a meniscus lens and further comprises a concave surface facing the image side.

5. The wide-angle lens assembly as claimed in claim 2, wherein:
the first lens is a meniscus lens and comprises a convex surface facing the object side and a concave surface facing the image side;
the third lens is a biconvex lens and comprises a convex surface facing the object side and another convex surface facing the image side;
the fourth lens is a biconvex lens with positive refractive power and comprises a convex surface facing the object side and another convex surface facing the image side;
the fifth lens is a biconcave lens with negative refractive power and comprises a concave surface facing the object side and another concave surface facing the image side; and
the sixth lens is a meniscus lens with positive refractive power and comprises a convex surface facing the object side.

6. The wide-angle lens assembly as claimed in claim 5, wherein:
the second lens is a biconcave lens with negative refractive power and further comprises another concave surface facing the image side; and
the sixth lens further comprises another convex surface facing the image side.

7. The wide-angle lens assembly as claimed in claim 1, wherein:
the fourth lens is with positive refractive power;
the fifth lens is with negative refractive power; and
the sixth lens is with positive refractive power.

8. The wide-angle lens assembly as claimed in claim 7, wherein the wide-angle lens assembly satisfies at least one of following conditions:
$$2.5 mm \leq Ra / Nd 4 \leq 15 mm ;$$
$$5 \leq Ra / d 67 \leq 62 ;$$
$$2 mm \leq Ra + R d \leq 19 mm ;$$
$$- 1 mm \leq fb + Rc \leq 2 mm ;$$
$$0.14 < Ra / fc < 6 \text{.62} ;$$
$$3 {mm}^{- 1} < Vdb / Rc < 7 {mm}^{- 1} ;$$
$$0.14 mm < Ra / Vdb < 1.34 mm ;$$
$$- 2.3 < f 1 / f < - 1.5 ;$$
$$- 38.3 < Vdd / ( fc / fb ) < - 15.2 ;$$
$$0.14 < f / TTL < 0.18 ;$$
$$3.1 < TTL / BFL < 8.1 ;$$
wherein Ra is the radius of curvature of the object side surface of the lens closest to the stop and between the stop and the image plane, Rd is a radius of curvature of an object side surface of the lens second closest to the image plane, Nd4 is a refractive index of the lens closest to the stop and between the stop and the image plane, d67 is an interval from an image side surface of the lens closest to the stop and between the object side and the stop to the stop along the optical axis, f is the effective focal length of the wide-angle lens assembly, f1 is an effective focal length of the first lens, fb is an effective focal length of the lens second closest to the stop and between the stop and the image plane, fc is an effective focal length of the lens closest to the image plane, TTL is the interval from the object side surface of the first lens to the image plane along the optical axis, BFL is the interval from the image side surface of the lens closest to the image plane to the image plane along the optical axis, L is the interval from the object side surface of the first lens to the image side surface of the lens closest to the image plane along the optical axis, Rc is a radius of curvature of an object side surface of the lens closest to the image plane, Vdb is an Abbe number of the lens second closest to the stop and between the stop and the image plane, Vdd is an Abbe number of the lens second closest to the image plane, and R11 is the radius of curvature of the object side surface of the first lens.

9. The wide-angle lens assembly as claimed in claim 8, further comprising a seventh lens disposed between the sixth lens and the image side, wherein the seventh lens is a plano-convex lens with positive refractive power and comprises a convex surface facing the object side and a plane surface facing the image side.

10. The wide-angle lens assembly as claimed in claim 7, wherein:
the first lens is a meniscus lens and comprises a convex surface facing the object side and a concave surface facing the image side;
the third lens comprises a convex surface facing the object side;
the fourth lens is a biconvex lens and comprises a convex surface facing the object side and another convex surface facing the image side;
the fifth lens is a biconcave lens and comprises a concave surface facing the object side and another concave surface facing the image side; and
the sixth lens is a meniscus lens and comprises a convex surface facing the object side.

11. The wide-angle lens assembly as claimed in claim 10, wherein:
the second lens is a meniscus lens with positive refractive power and further comprises a convex surface facing the image side; and
the sixth lens further comprises a concave surface facing the image side.

12. The wide-angle lens assembly as claimed in claim 11, wherein the third lens is a meniscus lens and further comprises a concave surface facing the image side.

13. The wide-angle lens assembly as claimed in claim 12, wherein the wide-angle lens assembly satisfies at least one of following conditions:
$$2.5 mm \leq Ra / Nd 4 \leq 15 mm ;$$
$$5 \leq Ra / d 67 \leq 62 ;$$
$$2 mm \leq Ra + R d \leq 19 mm ;$$
$$- 1 mm \leq fb + Rc \leq 2 mm ;$$
$$0.14 < Ra / fc < 6 \text{.62} ;$$
$$3 {mm}^{- 1} < Vdb / Rc < 7 {mm}^{- 1} ;$$
$$0.14 mm < Ra / Vdb < 1.34 mm ;$$
$$- 2.3 < f 1 / f < - 1.5 ;$$
$$- 38.3 < Vdd / ( fc / fb ) < - 15.2 ;$$
$$0.14 < f / TTL < 0.18 ;$$
$$3.1 < TTL / BFL < 8.1 ;$$
wherein Ra is the radius of curvature of the object side surface of the lens closest to the stop and between the stop and the image plane, Rd is a radius of curvature of an object side surface of the lens second closest to the image plane, Nd4 is a refractive index of the lens closest to the stop and between the stop and the image plane, d67 is an interval from an image side surface of the lens closest to the stop and between the object side and the stop to the stop along the optical axis, f is the effective focal length of the wide-angle lens assembly, f1 is an effective focal length of the first lens, fb is an effective focal length of the lens second closest to the stop and between the stop and the image plane, fc is an effective focal length of the lens closest to the image plane, TTL is the interval from the object side surface of the first lens to the image plane along the optical axis, BFL is the interval from the image side surface of the lens closest to the image plane to the image plane along the optical axis, L is the interval from the object side surface of the first lens to the image side surface of the lens closest to the image plane along the optical axis, Rc is a radius of curvature of an object side surface of the lens closest to the image plane, Vdb is an Abbe number of the lens second closest to the stop and between the stop and the image plane, Vdd is an Abbe number of the lens second closest to the image plane, and R11 is the radius of curvature of the object side surface of the first lens.

14. The wide-angle lens assembly as claimed in claim 13, further comprising a seventh lens disposed between the sixth lens and the image side, wherein the seventh lens is a plano-convex lens with positive refractive power and comprises a convex surface facing the object side and a plane surface facing the image side.

15. The wide-angle lens assembly as claimed in claim 10, wherein the third lens is a biconvex lens and further comprises another convex surface facing the image side.

16. The wide-angle lens assembly as claimed in claim 15, wherein:
the second lens is a biconcave lens with negative refractive power and further comprises another concave surface facing the image side; and
the sixth lens further comprises another convex surface facing the image side.

17. The wide-angle lens assembly as claimed in claim 16, wherein the wide-angle lens assembly satisfies at least one of following conditions:
$$2.5 mm \leq Ra / Nd 4 \leq 15 mm ;$$
$$5 \leq Ra / d 67 \leq 62 ;$$
$$2 mm \leq Ra + R d \leq 19 mm ;$$
$$- 1 mm \leq fb + Rc \leq 2 mm ;$$
$$0.14 < Ra / fc < 6 \text{.62} ;$$
$$3 {mm}^{- 1} < Vdb / Rc < 7 {mm}^{- 1} ;$$
$$0.14 mm < Ra / Vdb < 1.34 mm ;$$
$$- 2.3 < f 1 / f < - 1.5 ;$$
$$- 38.3 < Vdd / ( fc / fb ) < - 15.2 ;$$
$$0.14 < f / TTL < 0.18 ;$$
$$3.1 < TTL / BFL < 8.1 ;$$
wherein Ra is the radius of curvature of the object side surface of the lens closest to the stop and between the stop and the image plane, Rd is a radius of curvature of an object side surface of the lens second closest to the image plane, Nd4 is a refractive index of the lens closest to the stop and between the stop and the image plane, d67 is an interval from an image side surface of the lens closest to the stop and between the object side and the stop to the stop along the optical axis, f is the effective focal length of the wide-angle lens assembly, f1 is an effective focal length of the first lens, fb is an effective focal length of the lens second closest to the stop and between the stop and the image plane, fc is an effective focal length of the lens closest to the image plane, TTL is the interval from the object side surface of the first lens to the image plane along the optical axis, BFL is the interval from the image side surface of the lens closest to the image plane to the image plane along the optical axis, L is the interval from the object side surface of the first lens to the image side surface of the lens closest to the image plane along the optical axis, Rc is a radius of curvature of an object side surface of the lens closest to the image plane, Vdb is an Abbe number of the lens second closest to the stop and between the stop and the image plane, Vdd is an Abbe number of the lens second closest to the image plane, and R11 is the radius of curvature of the object side surface of the first lens.

18. The wide-angle lens assembly as claimed in claim 15, further comprising a seventh lens disposed between the sixth lens and the image side, wherein the seventh lens is a plano-convex lens with positive refractive power and comprises a convex surface facing the object side and a plane surface facing the image side.
